(19) United States
(12) Patent Application Publication
(10) Pub. No.: US 2021/0047214 A1
(43) Pub. Date: Feb. 18, 2021

(54) SYSTEMS AND METHODS FOR WATER AND SOLIDS TREATMENT

(71) Applicant: BLUE FROG TECHNOLOGIES LLC, Roscoe, IL (US)

(72) Inventor: Griscom BETTLE, III, Sarasota, FL (US)

(73) Assignee: BLUE FROG TECHNOLOGIES LLC, Roscoe, IL (US)

(21) Appl. No.: 16/969,300

(22) PCT Filed: Feb. 13, 2019
(86) PCT No.: PCT/US2019/017808

§ 371 Date: Aug. 12, 2020

Related U.S. Application Data
(60) Provisional application No. 62/629,958, filed on Feb. 13, 2018.

(51) Int. Cl. C02F 3/12; C02F 3/18; C02F 3/10; C02F 3/30; C02F 3/32; C02F 11/02

(52) U.S. Cl. CPC C02F 3/121; C02F 3/1284; C02F 3/18; C02F 2103/28; C02F 3/301; C02F 3/325; C02F 11/02; C02F 3/104

(57) ABSTRACT

The present disclosure is directed to a treatment system in a lagoon containing water that promotes the formation of biologically active granules that digest sludge in the lagoon, the lagoon comprising a bottom thereof, the water of the lagoon having a surface layer, the system including X number of water circulators in a cluster having an impeller disposed in the lagoon, wherein X is greater than or equal to three and hydraulic walls formed from at least some of the water expelled from each of a given pair of adjacent water circulators, wherein each of the hydraulic walls intersects at the midpoint of any two adjacent circulators, said hydraulic wall redirecting the expelled water downward towards the bottom of the lagoon, wherein the hydraulic walls at least partially surround at least one circulator.

### FIELD OF THE DISCLOSURE

The present disclosure relates generally to systems and methods of water and solids treatment. In one embodiment, the present disclosure relates to systems and methods for treating wastewater and wastewater solids.

Other embodiments relate to systems and methods for treating water and solids in paper mill ponds.

### BACKGROUND OF THE DISCLOSURE

Wastewater remediation is a broadly studied art with many innovations. Waste is treated aerobically, anaerobically or both. In waste water, especially from industrial waste, there is an accumulation of biomass, called biosolids or sludge (solids). It is costly and difficult to treat biosolids because the contents are virtually unknown and unknowable. Therefore, much of the biosolids are concentrated, digested, composted, land applied or entombed in landfills and the like.

Aerobic systems for treating waste products, including sludge, are known. They usually involve oxygen-addition, return activated sludge (RAS) as a source of active aerobic bacteria, a mixing step and a clarification step. Some of the clarified solids are returned as RAS or are wasted (WAS).

Anaerobic systems for treating waste products, including sludge, are also known. According to the Up-flow Anaerobic Sludge Bed (UASB), wastewater is pumped into a granular sludge bed to fluidize the granules. Fluid flow allows the gas to escape and the granules return to the fluidized bed. The granules self-form or can be introduced from an outside source.

The biochemistry of biofilms on minerals is known. A solid mineral is formed (or introduced as a seed crystal). Bacteria colonize onto the surface of these seed crystals. The first colonizers die as they make a sacrificial glue to bind the biofilm to the surface. More colonizers form a synergistic organized collection of bacteria. Bacteria secrete a biopolymer that can bind small mineral crystals to the surface, building up a granule.

Attached growth surfaces are known. In creeks, for example, slime grows on rocks as flooded aerated water flows by generally in one direction (downhill). In trickling filters, wastewater trickles down over rocks while air is bubbled up from below. Trickling filters are not flooded. An entire ecosystem grows in the thin, aerated film that grazes on the dead and dying attached bacteria. The grazing keeps the trickling filter from fouling.

The present disclosure provides systems and methods for unconventionally treating various waste waters and waste solids with one or more circulators, in large flow lagoons, as defined herein below and especially those lagoons containing sand bars, as described herein below.

### SUMMARY OF THE DISCLOSURE

The present disclosure provides a treatment system in a lagoon containing water that promotes the formation of biologically active granules that digest sludge in the lagoon, the lagoon comprising a bottom thereof, the water of the lagoon having a surface layer, the system comprising: (i) X number of water circulators in a cluster having an impeller disposed in the lagoon, wherein X is greater than or equal to five, at least one of said X number of water circulators being configured to: (a) cavitate water taken from the lagoon; and (b) expel the water after cavitation, wherein the water is expelled from said impeller at substantially constant impeller rotational speed at a cyclically varying flow rate radially across the surface from the centerline of each circulator such that at least some of the expelled water travels away from the water circulator in a path substantially parallel to the surface layer of the lagoon water; when said at least one water circulator is a number of water circulators less than X, the remainder of said X number of water circulators, other than said at least one water circulator, being configured to expel water taken from the lagoon, wherein the water is expelled (from the remaining water circulator(s)) such that at least some of the expelled water travels away from the water circulator in a path substantially parallel to the surface layer of the lagoon water; said X number of water circulators are disposed in the lagoon in a configuration such that: one circulator is substantially a center of a circle, and at least four other circulators are located substantially on a circumference of the circle and each water circulator is located substantially equidistant, along the circumference of the circle, from each adjacent one of the other water circulators; and (ii) hydraulic walls formed from at least some of the water expelled from each of a given pair of adjacent water circulators, wherein each of the hydraulic walls intersects at the midpoint of any two adjacent circulators, said hydraulic wall redirecting the expelled water downward towards the bottom of the lagoon, wherein the hydraulic walls at least partially surround at least one circulator. Circulators are arranged in clusters of three or more circulators. Larger ponds can have multiple clusters wherein the closest distance between clusters is ≥200 ft. the distance between circulators is dependent on the viscosity of the wastewater fluid. High solids ponds have closer spacing, clean water ponds have more distant spacing. In low solids ponds (<300 mg/l TSS), the maximum spacing is 100 ft. In medium solids ponds (200-3,000 mg/l TSS), the maximum spacing is 88 ft. In high solids ponds (>3.000 mg/l TSS) the maximum spacing between any two circulators is 64 ft. In practice, the spacing dimensions can be adjusted to fit the geometry of the pond. For example, the circulators closest to a berm or fixed curtain is about 44 ft. The corner spacing described above determines the cross-sectional surface directly treated by the cluster. This square surface area is retained by skilled artisans and converted into rectangles of the same surface area to fit the local geometry.

### BRIEF DESCRIPTION OF THE DRAWINGS

These and other features, aspects, and advantages of the present invention will become better understood with regard to the following description, appended claims, and accompanying drawings (which are not drawn to scale) wherein:

FIG. 1A illustrates an exploded schematic view of an example water circulator used in the present disclosure (in one specific example, such a water circulator may be a Blue Frog™ circulator);

FIG. 1B illustrates an assembled view of the embodiment shown in FIG. 1A;

FIG. 2A illustrates a graph showing a change in chemical oxygen demand and pH in a waste pool;

FIG. 2B illustrates a cross-sectional representation of sludge in a waste treatment pond;

FIGS. 3A-3C illustrate schematic representations of an aerator apparatus used in the present disclosure;

FIG. 4 illustrates a schematic representation of an aerator apparatus used in the present disclosure;

FIG. 5 illustrates a schematic plan view of a number of water circulators according to an embodiment of the present disclosure;

FIG. 6 illustrates a schematic plan view of a number of water circulators according to an embodiment of the present disclosure;

FIG. 7 illustrates a schematic plan view of a number of water circulators according to an embodiment of the present disclosure;

FIG. 8 illustrates a schematic plan view of a number of clusters of water circulators according to an embodiment of the present disclosure;

FIGS. 9A-9E illustrate an example of a water circulator operating to provide a reciprocating flow of water and cavitation according to an embodiment of the present disclosure. Schematic side views of the water circulators are provided;

FIG. 10A illustrates a schematic plan view of arrangement of certain water circulators;

FIG. 10B illustrates a schematic plan view of arrangement of certain water circulators;

FIGS. 11A-11D illustrate schematic plan views of various arrangements of water circulators according to embodiments of the present disclosure;

FIG. 12 illustrates a cross-section of a portion of a lagoon according to an embodiment of the present disclosure;

FIG. 13 illustrates a cross-sectional representation of the sludge in a pond after treatment with the system discussed in the present disclosure.

FIG. 14 is an overhead photograph of a lagoon.

FIG. 15 is a graphical representation of chloride levels over time.

FIG. 16 is a graphical representation of dissolved oxygen levels over time.

FIG. 17 is an overhead photograph of a lagoon.

FIG. 18 is an overhead photograph of a lagoon.

FIG. 19 is a photograph of a pond with included circulators.

FIG. 20 is a graphical illustration of ammonia levels over time.

FIG. 21 is a schematic view of a pond.

FIG. 22 is a graphical illustration of BOD levels over time.

FIG. 23 is a graphical illustration of sludge depth levels over time.

FIG. 24 is a schematic view of two ponds and circulators.

FIG. 25 is a graphical illustration of TSS levels over time.

FIG. 26 is a graphical illustration of BOD levels over time.

FIG. 27 is a magnified view of a crystal.

FIG. 28 is a magnified view of a crystal.

FIG. 29 is a photograph of a pond system.

FIG. 30 is a graphical illustration of BOD and flow levels over time.

FIG. 31 is a graphical illustration of sludge depth over time.

FIG. 32 is a graphical illustration of COD and conductivity over time.

FIG. 33 is a graphical illustration of conductivity and DO over varying depths.

FIG. 34 is a magnified view of different crystals.

FIG. 35 is a magnified view of a crystal.

FIG. 36 is a graphical illustration of COD and ammonia over time.

FIG. 37 is a graphical illustration of sludge depths.

FIG. 38 is photographs of a pond over time.

FIG. 39 s a photograph of a pond system with circulators.

FIGS. 40A-40D are photographs of a pond over time.

FIG. 41 is a photograph of a pond.

FIG. 42 is a photograph of circulators within a pond.

FIG. 43 is a graphical illustration of sludge depth over time.

### DETAILED DESCRIPTION OF DISCLOSURE

The present application will now be described in greater detail by referring to the following discussion and drawings that accompany the present application. It is noted that the drawings of the present application are provided for illustrative purposes only and, as such, the drawings are not drawn to scale. it is also noted that like and corresponding elements are referred to by like reference numerals.

In the following description, numerous specific details are set forth, such as particular structures, components, materials, dimensions, processing steps and techniques, in order to provide an understanding of the various embodiments of the present application. However, it will be appreciated by one of ordinary skill in the art that the various embodiments of the present application may be practiced without these specific details. In other instances, well-known structures or processing steps have not been described in detail in order to avoid obscuring the present application.

It will be understood that when an element as a layer, region or substrate is referred to as being “on” or “over” another element, it can be directly on the other element or intervening elements may also be present. In contrast, when an element is referred to as being “directly on” or “directly over” another element, there are no intervening elements present. It will also be understood that when an element is referred to as being “beneath” or “under” another element, it can be directly beneath or under the other element, or intervening elements may be present. In contrast, when an element is referred to as being “directly beneath” or “directly under” another element, there are no intervening elements present.

In the discussion and claims herein, the term “about” indicates that the value listed may be somewhat altered, as long as the alteration does not result in nonconformance of the process or structure to the illustrated embodiment. For example, for some elements the term “about” can refer to a variation of ±0.1%, for other elements, the term “about” can refer to a variation of ±1% or ±10%, or any point therein.

As used herein, the term “substantially”, or “substantial”, is equally applicable when used in a negative connotation to refer to the complete or near complete lack of an action, characteristic, property, state, structure, item, or result. For example, a surface that is “substantially” flat would either be completely flat, or so nearly flat that the effect would be the same as if it were completely flat.

As used herein terms such as “a”, “an” and “the” are not intended to refer to only a singular entity but include the general class of which a specific example may be used for illustration.

As used herein, terms defined in the singular are intended to include those terms defined in the plural and vice versa.

Reference herein to any numerical range expressly includes each numerical value (including fractional numbers and whole numbers) encompassed by that range. To illustrate, reference herein to a range of “at least 50” or “at least about 50” includes whole numbers of 50, 51, 52, 53, 54, 55, 56, 57, 58, 59, 60, etc., and fractional numbers 50.1, 50.2 50.3, 50.4, 50.5, 50.6, 50.7, 50.8, 50.9, etc. in a further illustration, reference herein to a range of “less than 50” or “less than about 50” includes whole numbers 49, 48, 47, 46, 45, 44, 43, 42, 41, 40, etc., and fractional numbers 49.9, 49.8, 49.7, 49.6, 49.5, 49.4, 49.3, 49.2, 49.1, 49.0, etc. In yet another illustration, reference herein to a range of from “5 to 10” includes whole numbers of 5, 6, 7, 8, 9, and 10, and fractional numbers 5.1, 5.2, 5.3, 5.4, 5.5, 5.6, 5.7, 5.8, 5.9, etc.

For the purposes of describing and claiming the present invention, the term “lagoon” is intended to refer to an artificial or naturally occurring body of water for the treatment of influent and/or effluent and/or for accommodating surface water that overflows drains during precipitation. In various examples, such a lagoon may contain salt water or fresh water. In other examples, such a lagoon may be a tank, a pool, a pond or a lake, including natural lake. In yet another example, such a lagoon may be an equalization tank (EQ) for treating influent (such EQ tanks are designed to equalize high/low flows, etc.). As defined, a lagoon does not have any natural current or flow to a larger body of water, such as a river, lake or ocean, but rather is a body of water contained in boundaries that may be natural, such as bordered by land or bordered by man-made structures. The lagoon, in an embodiment, is at least 3 feet deep and may be as deep as 100 feet or more. In this disclosure, the terms tank, pool, pond or lake or EQ are being used interchangeably.

In this disclosure, the lagoon is a large flow lagoon, such as, for example, a paper mill lagoon. There is a difference between lagoons with ≤3 MGD (low flow) and large flow lagoons with flows of about >10 MGD, >15M MGD, >20 MGD, about >25 MGD, about >30 MGD, about >35 or about >40 MGD (high flow) (such as paper mill lagoons).

The term continuous flow stirred-tank reactor (CSTR), also known as vat- or back-mix reactor, typically means a common ideal reactor type as used in chemical engineering. A CSTR often refers to a model used to estimate the key unit operation variables when using a continuous agitated-tank reactor to reach a specified output. The mathematical model works for all fluids: liquids, gases, and slurries. The behavior of a CSTR is often approximated or modeled after a Continuous Ideally Stirred-Tank Reactor (CISTR). All calculations performed with CISTRs assume perfect mixing. In a perfectly mixed reactor, the output composition is identical to the composition of the material mixed inside the reactor, which is a function of residence time and rate of reaction. If the residence time is 5-10 times the mixing time, this approximation is typically valid for engineering purposes. The CISTR model is often used to simplify engineering calculations and can be used to describe research reactors. In practice it can only be approached in particular in industrial size reactors.

In an embodiment, a cluster (or single circulator surrounded by a partial depth floating boom) such as described herein is not a CSTR, but approximates a CSTR (i.e., the cluster (or single circulator) has outflow but does not have complete recirculation; also the material inside the baffle is not homogeneous).

As defined herein, when it is indicated that the initial pH of the water in the lagoon is 7.5 or greater, it is understood that the pH is basic or neutral or slightly less than neutral. Thus, for example, if the pH is less than 5.0, which is acidic, then the lagoon is treated so that the pH of the water therein initially prior to operating the system herein is made more basic, i.e., until the pH of the lagoon is at least 7.5. In an embodiment, the initial pH of the lagoon may be as high as 10. In an embodiment, the initial pH of the water may range from 7.5 to 10.

As defined herein, the pH in different regions of the lagoon may be the same or different. For instance, the pH at the top of the lagoon may be different relative to the pH at the bottom of the lagoon. For example, the pH at the top of a lagoon (e.g., in a CSTR) may be 7.4, but at the bottom of the lagoon (e.g., in a CSTR) the pH may be 6.5. When pH is referred to, the pH could be the top, the bottom, anywhere in between or a combination thereof.

As described herein, an aspect of the present invention relates to the arrangement of the circulators in the lagoon. Various circulators may be used. An example of a circulating apparatus (see, e.g., U.S. Pat. No. 9,421,502, the contents of which are incorporated by reference) comprises an upper float chassis with a wider lower base thereof being equipped with an annular water outflow lip at essentially the surface level of the water; motor-driven means being mounted on the upper float chassis for drawing water into a water intake at a lower open end of the circulating apparatus for effectuating a flow of the water over the water outflow lip; a first set of concentric air hoses disposed at a first position between the water outflow lip and the water intake, the first set of concentric air hoses being in fluid communication with an air inlet disposed at a position on the upper float chassis above the surface level of the water; and a second set of concentric air hoses disposed at a second position between the water first set of concentric air hoses and the water intake, the second set of concentric air hoses being in fluid communication with the air inlet, the second set of concentric air hoses being horizontally offset from the first set of concentric air hoses such that air bubbles emitted by the second set of concentric air hoses rise to the surface level of the water between adjacent centric air hoses of the first set of concentric air hoses, wherein the first set of concentric air hoses and the second set of concentric air hoses emit jets of air bubbles into the water column between the water intake and the water outflow lip.

A further example of a circulator that can be used includes a circulating apparatus (see again, U.S. Pat. No. 9,421,502) comprising an upper float chassis with a wider lower base thereof being equipped with an annular water outflow lip at essentially the surface level of the water; motor-driven means being mounted on the upper float chassis for drawing water into a water intake at a lower open end of the circulating apparatus for effectuating a flow of the water over the water outflow lip; and an air injector disposed between the surface level of the water and the water intake, the air injector comprising a pair of venturis configured with respective outflows directed to impinge on each other, the air injector being configured to emit a high volume of air bubbles more than 500 standard cubic feet per hour mixed with water.

These circulators can be placed in any suitable configuration and location within the lagoon, including above or near “sand bars”. “Sand bars” are areas of built up sludge and other particulates within the lagoon. These sand bars can be any vertical accumulation of material, such that the sand bar has a thickness from about 6 inches from the bottom of the lagoon, to about 1 foot from the bottom of the lagoon, to about 2 feet from the bottom of the lagoon, to about 3 feet from the bottom of the lagoon, to about 4 feet from the bottom of the lagoon, to about 5 feet from the bottom of the lagoon, to about 6 feet from the bottom of the lagoon, to about 7 feet from the bottom of the lagoon, to about 8 feet from the bottom of the lagoon, to about 9 feet from the bottom of the lagoon, to about 10 feet from the bottom of the lagoon, or more.

In some embodiments, circulators be arranged to be directly over a sand bar, in other embodiments, these circulators can be adjacent a sand bar, or can straddle a sand bar. In other embodiments, circulators can be placed nearer one end of the sand bar, or nearer the middle of the sand bar.

Various circulators are illustrated herein.

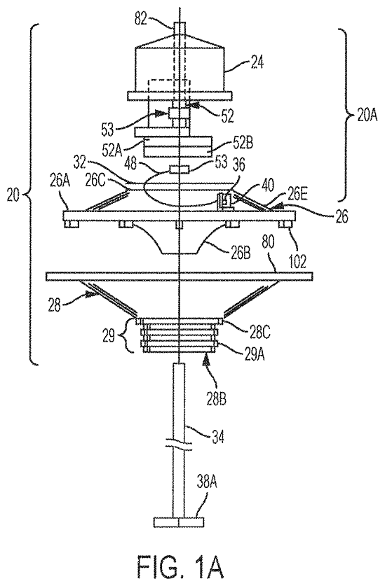

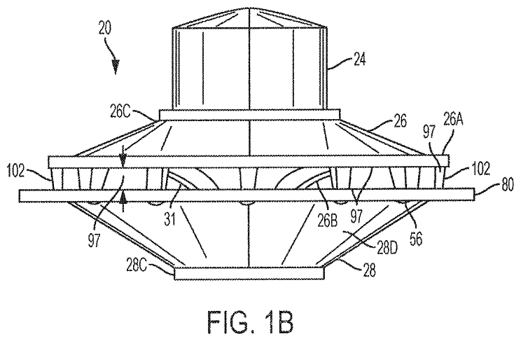

FIG. 1A provides an exploded view of circulator 20, which is exemplary of the circulator that may be used in the present disclosure, illustrating most of the unit's components and their interaction. FIG. 1A illustrates a Blue Frog™ Circulator (such a circulator may be referred to herein as a “BF” circulator), described in U.S. Pat. No. 9,421,502, the contents of which are incorporated by reference. Diverter 28, the lower portion of the unit, includes an inverted frusto-conical shell of substantially circular cross section and substantially straight sides. It has a protruding edge around its upper periphery, outflow lip 80, which serves to guide water discharged from circulator 20 into laminar flow along the water surface. The lower, narrowest portion of the diverter has a collar 28C, below which is located a substantially cylindrical standard connection fitting 29, including concentric ridges 29A. Diverter intake 28B is located inside connection fitting 29. These components are discussed in detail below. Drive shaft 34 extends through diverter intake 28B and mounts at its lower end an impeller hub mount 38A to which is removably attached the impeller and a plurality of blades (not shown here). In one example, drive shaft 34 is made of stainless steel or a similar strong, corrosion-resistant alloy, and is 1½ inches in diameter in a present embodiment. Optionally, the impeller can be a helical screw, In another example, the impeller may be an air fan.

Mounted above the diverter 28 is the circulator upper assembly 20A, with a float chassis 26, first including an upper frusto-conical shell 26E connected to a flat circumferential rim 26A, and mounting plate 32 mechanically attached to top surface 26C of float chassis 26 for use in mounting internal components discussed below. The float chassis 26 has a wider lower base portion formed by the base of the frusto-conical shell 26E and flat circumferential rim 26A. This wider base provides stability of the circulator in the water as well as accommodating the shape of the sectional diverter 26B attached to the lower portion of float chassis 26.

When the lower base portion has a diameter less than the upper outflow lip 80, the water profile is, in one embodiment, triangular. By the time the flow reaches the end of the upper outflow lip, there is a substantial horizontal vector and flow is radial away from the circulator centerline (that is, the outflow has a horizontal velocity vector that insures radial surface outflow).

The sectional diverter 26B resembles an inverted frustum of a cone with substantially parabolically curved sides inside and out. The upper edge of sectional diverter 26B connects to the bottom of float chassis rim 26A a plurality of supports 102 are integrally attached to the bottom of rim 26A to separate it from the outflow lip 80 when the float chassis 26 and diverter 28 are joined with mechanical connectors, as described below.

When assembled, the circulator 20 includes a motor cover 24 to protect the electric motor and other components, this cover being removably attached mechanically to the top of float-chassis 26. A lifting rod 82 is attached to the unit to facilitate moving the assembled unit. In one example, lubrication for the rotating parts is provided by a Petromatic™ grease cup 40 held by grease cup holder 36 fastened atop the rim 26A of float chassis 26, with a grease line 48 directing grease to bearing 53. An electric motor 52 is mounted on motor mounts 52B and connects to gear reducer 52A to drive the impeller attached to the impeller hub 38A at a suitable speed via drive shaft 34.

FIG. 1B provides a detailed view of the assembled circulator 20, including motor cover 24, float chassis 26 and diverter 28. Cover 24 is removably mechanically connected to the upper surface 26C of float chassis 26. Supports 102 are, in one example, molded as integral parts of the underside of rim 26A of float chassis 26, but can optionally be fabricated separately and attached by any suitable mechanical means. Float chassis 26 and diverter 28 are mechanically connected by bolts 56 or other suitable mechanical connectors passing through bolt holes from the underside of outflow lip 80 into the undersides of supports 102. Supports 102 are of a height appropriate to optimize the flow of water discharged through the outflow spaces 97 between the underside of rim 26A of float chassis 26 and outflow lip 80 of diverter 28 and are streamlined. In one embodiment, outflow lip 80 is six inches wide (that is, in this example, outflow lip 80 extends six inches beyond rim 26A).

The diverter intake 28B, within which the impeller operates, takes up water substantially vertically from below into a progressively expanding annular passage defined by the conical interior of diverter 28 and the parabolically curved exterior of the sectional diverter 26B. The intake water then emerges through outflow spaces 97 onto outflow lip 80 to flow in omni-directional laminar flow fashion onto the surface of the water in which the unit floats. The buoyancy of the circulator is designed so that it floats at a level such that water surface is above outflow lip 80, with water covering at least a portion of outflow spaces 97, and the water surface lying at the level of the underside of rim 26A or lower. This produces a laminar flow of water initially having a height of the height of outflow spaces 97.

The width of outflow lip 80 can be varied in different models to optimize the production of laminar flow for various volumes and rates of discharge. For example, a four-inch outflow space and six-inch outflow lip (that is, which extends six inches beyond rim 26A) are effective in producing laminar flow for a discharge of 7 million gallons/clay (MG/D) using three horsepower in “mix mode” (e.g., when the impeller runs counterclockwise). When the unit is operating in “aeration mode” (i.e., the impeller runs in the opposite direction (e.g., clockwise) from mix mode), the multiple plane surfaces of diverter 28 (28D) and the sectional diverter 26B (31), forming polygonal cross sections, are helpful in producing some bubbles in the water, which contribute to better mixing and aeration. In aeration mode the flow is 2 MG/D. In other words, if non-cavitating water flow is produced by counterclockwise impeller rotation, then cavitating water flow is produced by clockwise impeller rotation (and vice versa).

Connection fitting 29 below diverter collar 28C at the bottom of diverter 28 includes concentric ridges 29A and diverter inner surface inside (not shown in FIG. 1). Water can be taken up directly through diverter intake 28B or through an intake tube (not shown). Fitting 29 is designed to mate with a fitting for an externally corrugated/internally smooth intake tube.

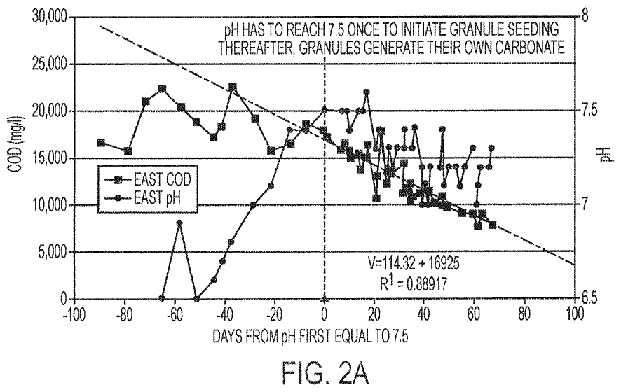

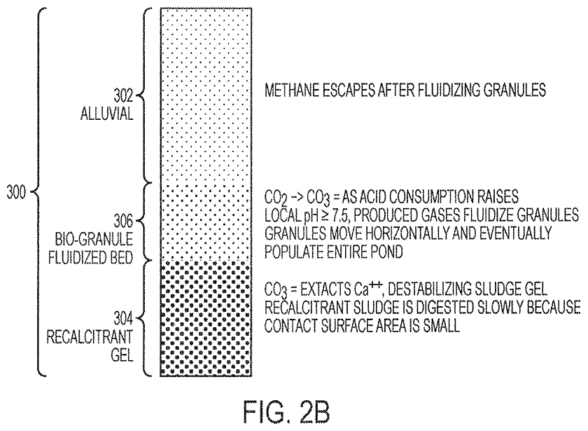

Referring now to FIG. 2A, which relates to use of a water circulator (see also, U.S. Pat. No. 9,421,502), the vertical line at zero days is the first day in which the pH=7.5. Prior to this date, the chemical oxygen demand (COD) was random; after this date, COD declined linearly. Colonizing bacteria that form the gas-forming biofilm populate the granules, once formed. The acid-consuming granule then creates CO₃⁻ anions locally to allow granules to grow. The small granules are fluidized by produced gas and colonize the bottom of the entire pond. The large granules locate on sludge that is not easily broken up (i.e., recalcitrant sludge) and slowly digest it.

Referring now to FIG. 2B, which relates to use of a water circulator (see also, U.S. Pat. No. 9,421,502), sludge 300 is a mixture of alluvial sludge 302, having total solids of less than 2.5%, and recalcitrant gelled sludge 304 comprising 2.5% or more total solids. The granules are sufficiently dense to pass through the alluvial sludge and sit on top of the recalcitrant gelled sludge to form a bio-granule fluidized bed 306.

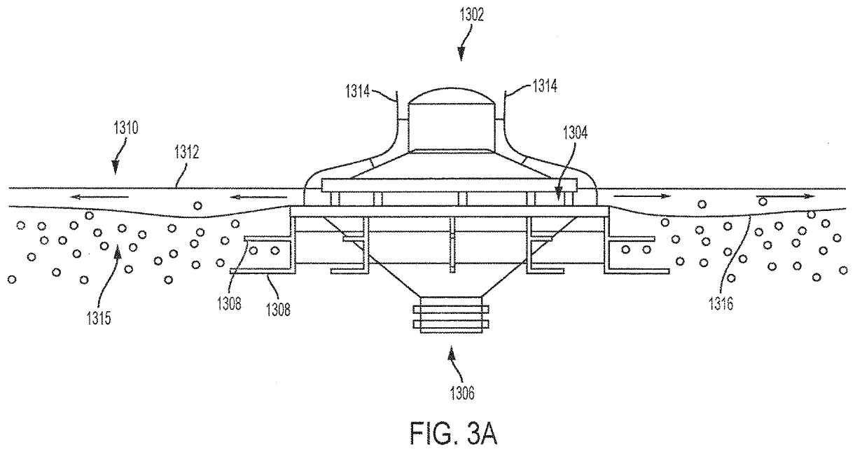

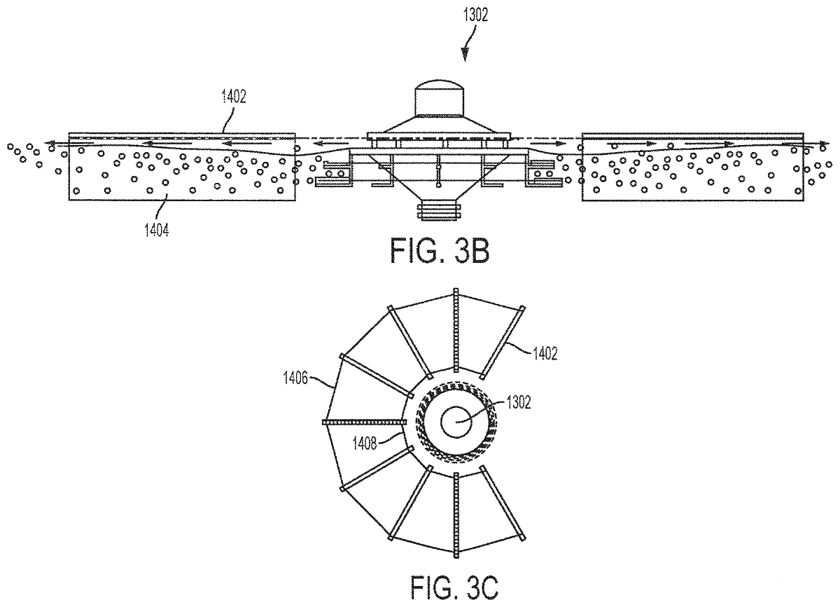

Another water circulator, identified as 1302, is illustrated in FIGS. 3A-3C. Circulator 1302 may be a Yellow Frog™ Circulator (or “YF” circulator), which may be used as a circulator in the disclosure herein. These figures illustrate an apparatus for making vertical-rising bubbles move horizontally. Bubble escape velocity is proportional to bubble radius until the bubble is greater than 1 mm. Thereafter the escape velocity is constant. The internal components of the circulator 1302 (which is sometimes referred to herein as “YF 1302”) are similar to those shown in FIGS. 1A and 1B, thus only distinguishing features will be described herein below.

Aerators are historically designed to maximize droplet macro surface area (number of drops×area/droplet) in air or make air bubbles small (greater macro surface area) and deep (more detention time for oxygen transfer). These strategies consume large energy by throwing water up into the air or pushing gas deep into the water column to increase the oxygen transfer rate (OTR), which is a helpful way to measure efficiency in aerobic systems (lbs O₂/hp×hr).

When bubbles rise to the surface, the elevation of the gas/liquid mixture rises and fluid flows radially away from the bubble. If bubbles are added in a line, e.g. from an aerator hose, the flow is left and right from the axis of the hose.

If droplets are thrown radially from a splasher aerator, the drops have a horizontal and vertical vector. The horizontal vector makes the fluid flow away from the splasher.

The YF 1302 is an improved aerator that decouples bubble formation and fluid flow. YF 1302 is a circulator with radial surface outflow 1304, a water intake 1306, air intake 1314, and two sets of four concentric rings of aeration hose 1308 connected to the air intake 1314.

The concentric rings 1308 are positioned at sufficient position apart below the surface of the water for the emission of microbubbles to rise between the aeration hoses of the upper set of concentric rings. In an embodiment, the concentric rings are positioned at 9 inches and 18″ below the surface, respectively. Additionally, the lower (second) set of concentric rings 1308 are staggered with respect to the upper (first) set of concentric rings 1308, such that micro-bubbles emitted by the lower set of concentric rings 1308 rise between the aeration hoses of the upper set of concentric rings 1308. The above positioning of the concentric rings 1308 is intended for illustrative purposes. The upper concentric ring is positioned more than 2 times deeper in the water column than the depth of the water discharge from the radial surface outflow 1304 with respect to the surface of the water. At twice the depth, the air bubbles emitted by the upper set of concentric rings 1308 are below the wave/no wave interface created by the water discharge.

In an embodiment, each of the two sets of concentric rings 1308 is connected to a respective air intake 1314, such that the flow between the upper set of concentric rings 1308 and the lower set of concentric rings 1308 is equalized. Since there is a minimum 6 inch gap between the upper set of concentric rings 1308 and the lower set of concentric rings 1308, higher air pressure is needed to push air to the lower set of concentric rings 1308. The depth of the vertical inlet 28B sets the maximum spacing.

The bubbles are externally produced at an intermediate elevation between the aerator inlet and outlet. If the bubbles are produced below the inlet, the bubbles are sucked into the inlet and coalesce. If the bubbles are produced above the outflow, the bubbles escape and do not flow horizontally.

As shown in FIG. 3A, the water exiting from radial surface outflow 1304 is introduced below the water surface 1310. Additionally, the introduction of micro air bubbles into the water column creates a region of low viscosity 1315 in comparison to the surrounding water. Thus, a boundary 1316 is created between the typical, high viscosity water 1312 and lower viscosity aerated water 1315. This boundary 1316 acts to dampen the rate of rise of the micro air bubbles. As a consequence, the micro air bubbles are directed horizontally for an extended distance before reaching the water surface 1310.

Radially outflowing, well-mixed, water hydraulically redirects rising bubbles horizontally, i.e. redirection is not with machines or steering means. Bubbles less than 1 mm radius are re-entrained in the diverging surface flow lines. The diverging flow lines separate individual bubbles one from another to prevent coalescing and consequent loss of macro surface area.

The radial, well-mixed, substantially gas-free, outflow is non-linear and eddies are formed that continuously re-entrain bubbles of less than 1 mm radius. When small bubbles are re-entrained, detention time is increased sufficiently for oxygen to transfer to the water.

In an embodiment of the YF aerator 1302, only one set of concentric rings 1308 is provided. In another embodiment more than two sets of concentric rings 1308 are provided, each disposed at different vertical positions.

Additionally, an embodiment of the YF aerator 1302, as shown in FIGS. 3B and 3C, is in fluid communication with optional, radial, vertical, semi-permeable, attached growth surfaces 1404 disposed from radially extending spokes 1402. For clarity of the structure, FIG. 3B only shows two spokes 1402 and growth surfaces 1404 attached to the floating spoke and hanging vertically down, with a weighted pipe at the lower edge of the growth surfaces 1404 that keeps the growth surface substantially vertical. However, in actuality, the YF 1302 of the present invention has a plurality of spokes 1402, as shown in FIG. 3C, extending radially from the central axis of the YF 1302 and spaced at intervals about the circumference of the YF 1302. With the growth surfaces 1404 disposed as shown in FIG. 3B, large radius bubbles, greater than 1 mm radius, are obstructed from reaching the water surface for a period of time sufficient to discharge their oxygen to the attached growth surface. The attached growth has a DO greater than 1 mg/l for a spoke length of 10 feet. The spokes 1402 and growth surfaces 1404 are optionally equipped on the YF 1302 when a specific waste treatment project would benefit from the additional vertical growth surfaces as discussed above, for example if carbon and or nitrogen reduction is desired. Thus, the YF 1302 discussed in this disclosure encompasses both embodiments with and without the spokes 1402 and growth surfaces 1404. The term “DO” refers to dissolved oxygen (mg/l). This is the concentration of O₂ in the water.

As shown in FIG. 3C, the optional spokes 1402 are not mechanically connected to the YF 1302, but rather float freely and substantially encircle the YF 1302. In the embodiment shown in FIG. 3C a large opening is provided at one side of the arrangement of spokes 1402 to allow easy access to and removal of the YF 1302. However, the spokes 1402 may, in an embodiment, form a completed circle around the YF 1302. Each of the spokes 1402 are connected to adjacent spokes 1402 by optional connecting members 1406 and 1408. Long connecting members 1406 are disposed on the outside perimeter of the arrangement, while shorter connecting members 1408 are disposed on the inside perimeter. This arrangement of connecting members 1406 and 1408 forces the spokes into a radial configuration. The length of the long connecting members 1406 and short connecting members 1408 are determined by the length of the spokes 1402 and the desired angle formed between adjacent spokes 1402.

It was determined experimentally that aerobic conditions do not exist beyond spoke lengths of 15 feet. The anaerobic section grows thick slime, for example, 8 to 12 inches thick, e.g., 10 inches thick, that sinks the tip of the spoke. The spokes are intentionally shortened to insure that the entire growth surface is sufficiently aerated that the shavers and grazers have sufficient oxygen to thrive. For example, spokes may be loft long, with a growth surface of 27″ deep and 2″ thick.

The aerobic matrix, i.e. the optional growth surface 1404, is self-cleaning as long as it is aerobic. The natural color of the matrix is black. The in-use color is tan.

The matrix total volume is populated with sludge worms, insect larvae and nematodes (round worms). The worms graze on the colonizing bacteria and eat the bacteria. The grazers keep the matrix clean (self-cleaning), if the DO is greater than 1 mg/L. In an embodiment, the YF circulator, as illustrated in FIGS. 3A-3C pumps 7 MGD of water through an annular space of about 4 inches high with a diameter of about 7 ft (7.33 ft). The exit velocity is less than 2 ft/sec. Turbulent flow in clean water is typically established at velocities greater than or equal to approximately 7 ft/sec. Substantially non-turbulent flow leaves the YF flowing radially and horizontally away from the centerline of the YF. However, the impeller turns slowly enough, e.g. about 100 rpm to about 170 rpm, such as at about 150 rpm, to impart a slight counterclockwise curvilinear flow pattern with a distinct cross vector that moves water tight-to-left as well as out from the centerline.

As water flows out from the YF 1302, coarse and fine bubbles rise vertically into the horizontal gas-free, non-turbulent water flow. The coarse and fine bubbles are entrained in the outflowing eddies to a diameter of about 50 ft. Non-turbulent flow minimizes bubble coalescing. The bubbles remain in the water column much longer so there is sufficient detention time to transfer bubble-interior oxygen to the water. This results in a 5-fold increase in oxygen transfer efficiency to 3 lbs O₂/hp×hr.

One aspect of the YF and spokes is the incubation of microalgae and nitrifiers. Without wishing to be bound, it is believed that nitrifiers “hitchhike” on the microalgae and are dislodged by the worm feeding activity. Once dislodged, the microalgae/nitrifier floats up and down the water column (about 7 ft max). The algae provide DO, attached growth surface and shade plus diurnal transport up and down the water column. The net effect is to vastly increase the detention time of nitrifiers in a low carbon, high DO environment. Further, the Total Nitrogen load, e.g. primarily winter ammonia is reduced to <1 mg/l is reduced throughout the year. Total nitrogen is the sum of total. kjeldahl nitrogen(ammonia, organic and reduced nitrogen) and nitrate-nitrite. It can be derived by monitoring for organic nitrogen compounds, free-ammonia, and nitrate-nitrite individually and adding the components together.

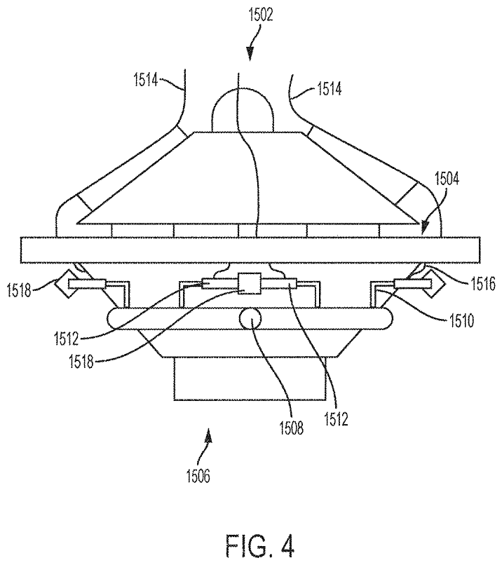

Another water circulator, identified as 1502, is illustrated in FIG. 4. Circulator 1502 can be a Gold Frog™ Circulator (or “GF circulator”), which may be used as a circulator in the disclosure herein. The circulator 1502 (which is sometimes referred to herein as “GF 1502”) is an aerator with one or more air jets 1518 for injecting an external source of air bubbles at a vertical position between the water inlet 1506 and water outlet 1504. The injected air bubbles rise under the well-mixed radially outflowing water ejected from the water outlet 1504. The rising air bubbles elevate the outflowing water above the mean elevation of the surrounding water such that gassy water flows left and right. The internal components of the GF circulator are similar to those shown in FIGS. 1A and 1B, thus only distinguishing features are shown in FIG. 4.

In an embodiment, two impinging venturis 1512, are disposed within the air jets 1518 in order to generate a high volume of micro air bubbles in a jet of water emitted through the air jet 1518. Water is drawn into the venturis 1512 through a water inlet 1508 and piping 1510. Additionally, air intake hoses 1514 are provided above the water surface which feed air to the venturis 1512 by way of respective air hoses 1516. Each of the impinging venturis 1512 directs jets of micro air bubbles at one another at a closing velocity of approximately 7 ft/sec and a downward angle of 15°. The closing velocity can be as great as 10 ft/sec. The closing velocity may range from 7 ft/sec to 10 ft/sec. Downward angles may range from 3° to 30°. Flow rates can be between 2 MGD and 7 MGD. Skilled artisans can adjust the downward angle to maximize detention time in the water column without deviating from the present invention. The impingement fractures small bubbles into micron-sized bubbles; the downward angle maximizes the time the bubbles are in the water column.

The shear from impinging venturis 1512, wherein each venturi 1512 has turbulent flow, will hydrolyze triglycerides into fatty acid and glycerin. The fatty acid (soap) in turn lowers the surface tension of the water. Lower surface tension (“wetter water”) is particularly advantageous with land application of wastewater from manure ponds and municipal waste.

This aerator eliminates hoses inside the chassis that transfer gassy water present in certain conventional devices. The impingement T (or T pipe) is rotated horizontal to an elevation intermediate between the inlet and the outlet of the circulator. For example, the impingement T exit is angled at −15° from the horizontal such that each pair of venturis discharges microbubbles down-then-up such that the net flow is horizontal and under the outflowing laminar gas-free water. In one example, with a given pair of venturis, the combined collision velocity inside the T exit is >7 ft/sec.

Microbubbles generated by the GF 1502 rise up into the outflowing laminar flow and are entrained and made to move horizontally without any one stream intersecting with the adjacent stream, doubling the efficiency over certain conventional devices.

Thus, like the YF embodiment, the GF embodiment discharges gas at an intermediate elevation between the pump inlet and outlet where externally-generated bubbles rise vertically into horizontal outflowing laminar flow with a flow vector aligned with the centerline of the circulator and a flow vector at right angles to the centerline flow vector.

An embodiment of the GF 1502 removes the transfer line and the flow resistance and redirects the impingement T so that the discharge from the air jet 1518 ranges from about 10 to about 20 degrees below the horizontal, such as −15° below the horizontal, from 2 to 10 inches, e.g., 4 inches below the water surface. For instance, it was found that the combination of eliminating back pressure and directing free flowing gassy fluid at an angle of 15 degrees below the horizontal and 4 inches below the water surface increased oxygen transfer efficiency by about 400%.

Operating at low backpressure is known. What is unexpected is combining low backpressure venturi operation with horizontal radial outflowing gas-free water after impingement mixing below horizontally outflowing gas-free water to detain bubbles in the water column for a time sufficient to extract 20% of the oxygen.

In one example, the venturi-equipped GF 1502 pulls 2,023 lbs O₂/day through the sum of the venturis. The measured oxygen transfer rate (OTR) is ˜4× (max OTR=6.5 lbs O₂/hp×hr) the high backpressure prior design of 0.24 lbs O₂/hp×hr.

In the world of mechanical aerators, this is a low efficiency aerator. However, the GE 1502 provides additional advantages. The GF 1502 adds oxygen, lowers surface tension, lowers E. coli, and lowers TSS. In combination with an optional circumferential baffle and a YF, low suspended solids are achievable. Without wishing to be bound, the cavitation at the point of impingement shears flagella from slow-settling flagella-bearing bacteria. Thus, the cavitation increases the rate of settling.

Using the circulators, as described hereinabove; they are arranged as described herein.

An embodiment of the present disclosure is directed to, inter alia, a system for the treatment of sludge in a lagoon containing water that promotes the formation of biologically active granules that digest sludge in the lagoon, the lagoon including a bottom thereof, the water of the lagoon having a surface layer, the system comprising: X number of water circulators having an impeller disposed in the lagoon in a cluster, wherein X is greater than three, e.g., 3, 4, 5, 6, 7, 8, 9, 10, 11, 14, 17, etc; at least one of said X number of water circulators being configured to: (a) cavitate water taken from the lagoon; and (b) expel the water after cavitation, wherein the water is expelled from said impeller at constant impeller rotational speed at a cyclically varying flow rate radially across the surface from the centerline of each circulator such that at least some of the expelled water travels away from the water circulator in a path essentially parallel to the surface layer of the lagoon water; when said at least one water circulator is a number of water circulators less than X, the remainder of said X number of water circulators, other than said at least one water circulator, being configured to expel water taken from the lagoon, wherein the water is expelled (from the remaining water circulator(s)) such that at least some of the expelled water travels away from the water circulator in a path essentially parallel to the surface layer of the lagoon water; (c) a respective hydraulic wall formed from at least some of the water expelled from each of a given pair of adjacent water circulators, where horizontal flow vectors of the expelled water are substantially equal and opposite between adjacent circulators, said hydraulic wall redirecting the expelled water downward towards the bottom of the lagoon.

In an embodiment, each of the hydraulic walls intersects essentially at the center point. Moreover, in an embodiment, each of a given pair of adjacent hydraulic walls forms a respective hydraulic corner where the given pair of hydraulic walls intersect essentially at the center point. In this embodiment, the hydraulic walls direct water expelled from each of the water circulators into the hydraulic corners; and (the hydraulic corners force at least some of the water directed therein by the hydraulic walls downward, towards the bottom of the lagoon. The flow pattern is “perimeter flow”, that is radially out from the centerline of the circulator to the said hydraulic wall (or baffle) and then down over a porous bed of lagoon granules and then back to the circulator inlet. Perimeter flow is analogous to “flow around a hard-boiled egg”. That is, the perimeter is circulated, not the interior.

In an embodiment, all of the circulators cavitate water from the lagoon and expel the water after cavitation. In another embodiment, at least 1 less than X circulators cavitate water from the lagoon and expel the water after cavitation. In an embodiment, at least 50% of the circulators cavitate water and expel the water after cavitation.

When the water is expelled from the water circulators arranged substantially around the circumference of a circle, at least some of the water expelled travels away from the water circulator in a path essentially parallel to the surface layer of the lagoon water.

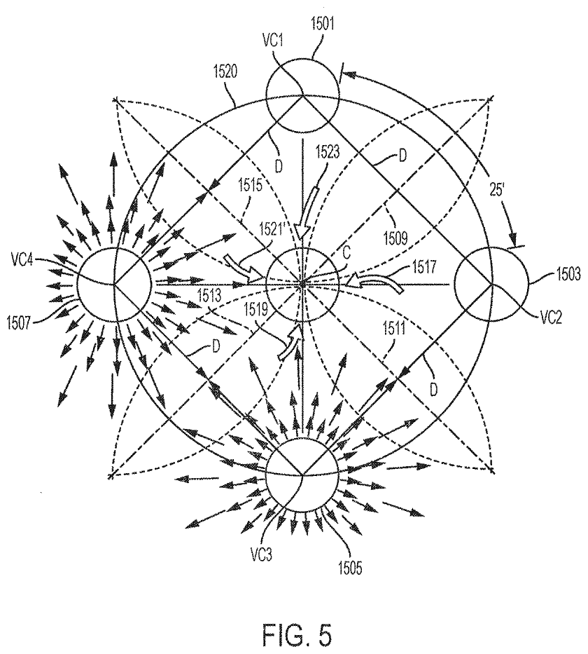

Referring now to FIG. 5 (showing a schematic plan view of a number of water circulators 1501, 1503, 1505, 1507 disposed in a lagoon), a system according to an embodiment of the present disclosure will be described.

At least one of said X number of water circulators is configured to: cavitate water taken from the lagoon; and expel the water after cavitation, wherein the water is expelled such that at least some of the expelled water travels away from the water circulator in a path essentially parallel to the surface layer of the lagoon water (in this example, water circulators 1501 and 1505 comprise the at least one water circulator). The cavitation may be carried out via a reciprocating flow of water, as described in more detail below.

Further, when said at least one water circulator is a number of water circulators less than X, a remainder of said X number of water circulators other than said at least one water circulator is configured to expel water taken from the lagoon, wherein the water is expelled such that at least some of the expelled water travels away from the water circulator in a path essentially parallel to the surface layer of the lagoon water (in this example, water circulators 1503 and 1507 comprise the remainder of water circulators). The remainder of the water circulators may operate in a non-reciprocating flow manner,

Further still, said X number of water circulators can be disposed in the lagoon in a configuration such that: each water circulator is located essentially on a circumference of a circle (see call out number 1520) defined by a predetermined radial distance from a center point (see “C”) of the circle and each water circulator is located essentially equidistant, along the circumference of the circle, from each adjacent one of the other water circulators.

Moreover, at least some of the water expelled from each of a given pair of adjacent water circulators (see 1501-1503; 1503-1505; 1505-1507; and 1507-1501) forms a respective hydraulic wall (see the dashed lines at 1509; 1511; 1513; 1515), each of the hydraulic walls (see 1509; 1511; 1513; 1515) intersect essentially at the center point (see “C”), and each of a given pair of adjacent hydraulic walls (see 1509-1511; 1511-1513; 1513-1515; and 1515-1509) forms a respective hydraulic corner (see 1517; 1519; 1521; and 1523) where the given pair of hydraulic walls intersect essentially at the center point (see “C”). The hydraulic walls are formed where horizontal outflow vectors from adjacent water circulators are equal and opposite (see, e.g. FIG. 5 showing hydraulic wall 1509 between water circulators 1501/1503, hydraulic wall 1511 between water circulators 1503/1505, hydraulic wall 1513 between water circulators 1505/1507, and hydraulic wall 1515 between water circulators 1507/1501.

In an embodiment, each hydraulic wall in a 4 pack cluster is the hypotenuse of a right triangle (having the radius from the center of the circle to the centerline of the water circulator as each of the two shorter sides). That is, in an embodiment, the square of the length of each hydraulic wall in a 4 pack cluster is equal to the sum of the squares of the lengths of the other two sides. Further, in an embodiment, a 4 pack cluster will have each water circulator provide 25% of its outflow to a given hydraulic wall.

In addition, the hydraulic walls (see 1509; 1511; 1513; 1515) direct water expelled from each of the water circulators into the hydraulic corners (see 1517; 1519; 1521; and 1523) and the hydraulic corners force at least some of the water directed therein by the hydraulic walls downward, towards the bottom of the lagoon.

Other circulators that intentionally cavitate and/or have air injected could be used. Without wishing to be bound, it is believed that the hydraulic wall is formed when the horizontal outflow vectors between any two adjacent circulators are equal and opposite. The opposing flows well up along the collision line until the gravity head is sufficient to redirect the horizontal outflow vertical and down. The water is pulled horizontally back to the inlet creating an upper circulating zone. The net result is a reduced perimeter flow as described herein. An induced flow occurs in the anoxic zone below the aerobic zone. The cavitation, described before, creates seed crystals of calcium carbonate, calcium phosphate and optionally struvite. These small crystals circulate and grow until they are of sufficient size to precipitate into the anoxic zone. The flow alternates between aerobic and anoxic. Without wishing to be bound, soluble BOD created by aerobes is converted to biosolids in the aerobic zone and settles in the lagoon granule bed for conversion to gas.

In this embodiment, when there are a plurality of hydraulic corners, flow is concentrated at the center “C”. Water flows down each hydraulic corner to the bottom of the circulator inlet where it follows a pathway back to the water circulator inlets.

During the flow return process, dense seeds (e.g., biofilm coated calcium carbonate and enzymes formed by the cavitation and heavy hydrolytic brine) settle at the bottom in the vicinity of “C”. The high concentration in the vicinity of “C” promotes excess lagoon granule initiation. Thus, a plurality of hydraulic corners in combination with reciprocating flow initiates more lagoon granules. More lagoon granules digest sludge faster. The lagoon granules form a porous bed below the circulation area.

Still referring to FIG. 5, it is noted that in one example, the cavitation of water by the at least one water circulator results from a reciprocating flow of water in the at least one water circulator (discussed in more detail below). Further, it is noted that while the example of this FIG. 5 provides for circulators 1501 and 1505 cavitating the water (via reciprocating flow) and circulators 1503 and 1507 being the remainder of the water circulators and not using reciprocating flow, any other desired number of water circulators may be the reciprocating flow or remainder water circulators. In addition, the reciprocating flow and remainder water circulators may be located at any desired locations on the circumference of the circle. in one specific example, there may be an even number of water circulators and at least two water circulators that are located opposite each other (that is, located a maximum distance apart across the circle) may be the reciprocating flow water circulators (wherein at least some water circulators are remainder water circulators without reciprocating flow).

In an embodiment, the reciprocating flow is adjusted so that the change in direction of the flow of water occurs at a time interval ranging from 0.1 sec to 8 seconds, and in another embodiment, from 0.15 seconds to 6 seconds, and in still another embodiment, from 0.17 sec to 5.5 seconds.

Still referring to FIG. 5, it is noted that each hydraulic corner (see 1517; 1519; 1521; and 1523) has an interior angle defined by a respective pair of hydraulic walls intersecting at the center point to form the hydraulic corner. That is: the interior angle of hydraulic corner 1517 is formed by hydraulic walls 1509 and 1511 and faces towards water circulator 1503; the interior angle of hydraulic corner 1519 is formed by hydraulic walls 1511 and 1513 and faces towards water circulator 1505; the interior angle of hydraulic corner 1521 is formed by hydraulic walls 1513 and 1515 and faces towards water circulator 1507; and the interior angle of hydraulic corner 1523 is formed by hydraulic walls 1515 and 1509 and faces towards water circulator 1501. Further, each interior angle may be essentially 360/X degrees (X being the number of water circulators). In an embodiment, the interior angles range from 120° to 36°.

As described hereinabove, the angle of the hydraulic corners is 360°/X. where X is as defined herein. When X is 3, for example, the angle of the hydraulic corner is 120°, and when X is 4, the angle of the hydraulic corner is 90°, and when X is 5, the angle of the hydraulic corner is 72°, and when X is 6, the angle of the hydraulic corner is 60°. In an embodiment, an angle of the hydraulic corners is 90° (e.g., when there are four water circulators in the configuration). In this embodiment 90°=360°/4 water circulators.

Still referring to FIG. 5, it is noted that in one embodiment, the water is expelled from each water circulator such that at least some of the expelled water travels away from the water circulator in a path along the surface layer of the lagoon water. Regarding the path of the expelled water see, for example, the radial arrows shown around water circulators 1505 and 1507 (of course, the water may be radially expelled from all of the water circulators even though only two sets of radial arrows are shown in this FIG. 5).

Of further note, while FIG. 5 provides an example where X equals 4, other configurations in which X is (for example) an integer greater than 2 and less than 11 may be provided.

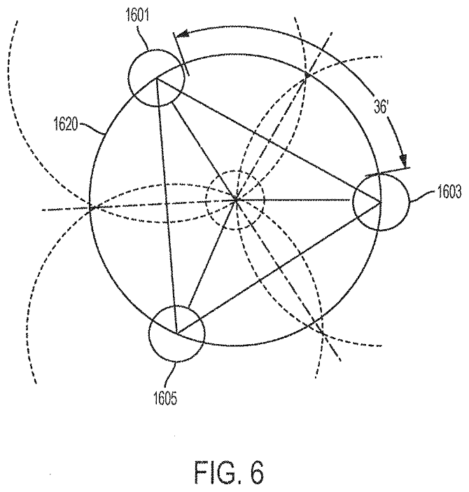

In this regard see, for example, FIG. 6 showing a schematic plan view of three water circulators disposed in a lagoon. More particularly, water circulators 1601, 1603 and 1605 are disposed on circle 1620 to produce hydraulic walls and hydraulic corners in a manner similar to FIG. 5.

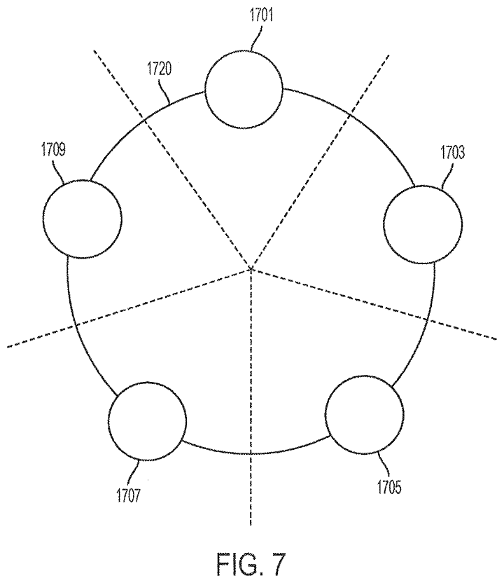

See also, for example, FIG. 7 showing a schematic plan view of five water circulators disposed in a lagoon. More particularly, water circulators 1701, 1703, 1705, 1707 and 1709 are disposed on circle 1720 to produce hydraulic walls and hydraulic corners in a manner similar to FIG. 5.

In yet another embodiment, the present disclosure includes the lagoon containing 2 or more clusters comprised of X circulators as above, wherein each of the clusters are comprised of X circulators. The number of circulators in each of the clusters may be the same or different. The lagoon may contain Y number of clusters, from 2 to 20 clusters of these circulators, while in another embodiment, the lagoon may contain from 2 to 6 clusters, while in another embodiment, the lagoon contains from 3 to 4 clusters.

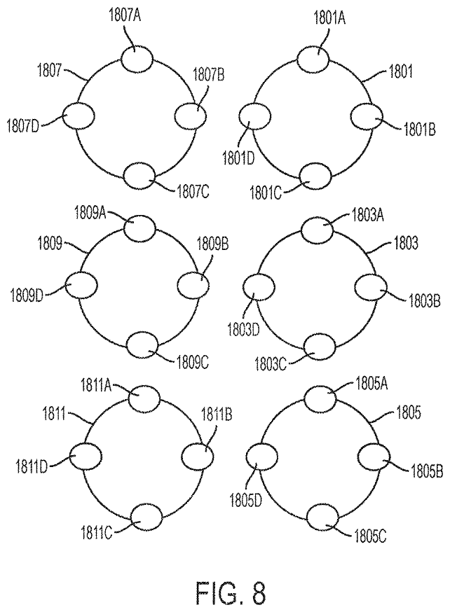

Further, each of the Y number of clusters of water circulators may comprise a set of water circulators in a configuration such as shown in one of FIG. 5-7 or 11A-11D (or any other desired configuration). In one specific example, shown in FIG. 8, six clusters (see 1801, 1803, 1805, 1807, 1809 and 1811) are provided. Further each of these six clusters includes therein four water circulators. More particularly, cluster 1801 includes water circulators 1801A-1801D; cluster 1803 includes water circulators 1803A-1803D; cluster 1805 includes water circulators 1805A-1805D; cluster 1807 includes water circulators 1807A-1807D; cluster 1809 includes water circulators 1809A-18093D; and cluster 1811 includes water circulators 1811A-1811D.

Clusters may be provided in any desired number and may be positioned relative to each other in any desired configuration. In one example, a water circulator in one cluster may expel water that interacts with water expelled by a water circulator in another cluster such as to form one or more hydraulic walls and/or one or more hydraulic corners. In one specific example (with reference to FIG. 8) water circulator 1801C may expel water that interacts with water expelled by water circulator 1803A (of course, any other pairs of water circulators may operate in a similar manner).

In another embodiment, water circulators and/or clusters as described herein may be provided in multiple lagoons at a given location.

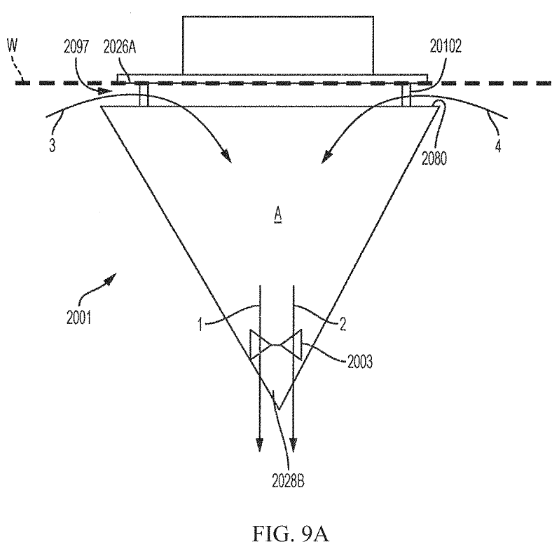

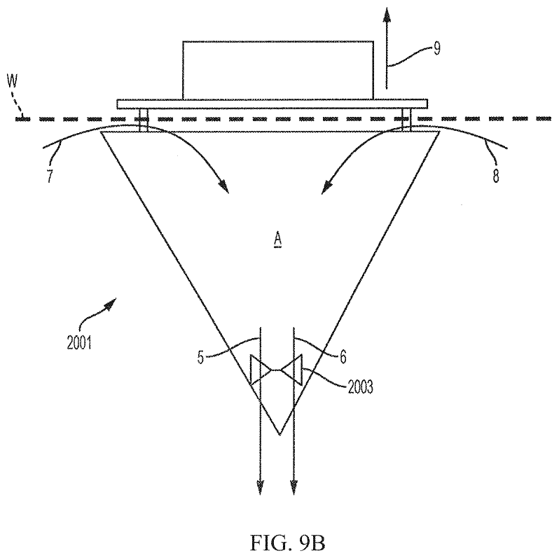

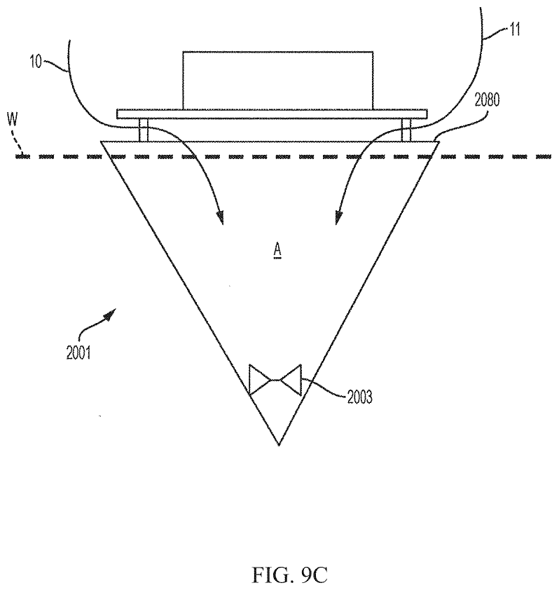

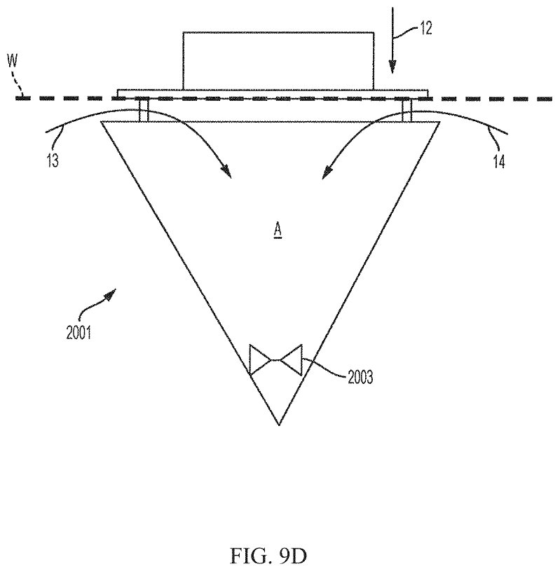

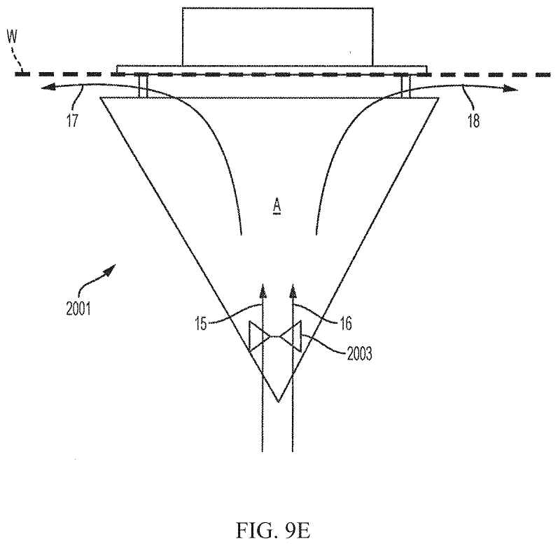

Referring now to FIGS. 9A-9E an example of a water circulator operating to provide a reciprocating flow of water and cavitation is provided. More particularly, as seen in FIG. 9A, water circulator 2001 floats such that waterline W is above outflow lip 2080 (this water circulator 2001 is shown in a simplified schematic form; however, certain components correspond to the water circulator shown in FIGS. 1 and 1A as follows: outflow lip 2080 corresponds to outflow lip 80, supports 20102. correspond to supports 102, rim 2026A corresponds to rim 26A, outflow spaces 2097 correspond to outflow spaces 97, and diverter intake 2028B corresponds to diverter intake 28B).

Still referring to FIG. 9A, the example process begins at time T₀. At this time T₀, impeller 2003 rotates to pull water from cavity A. The water pulled from cavity A is pushed down and out substantially vertically through diverter intake 2028B (see arrows 1 and 2). In addition, the water pushed down and out through diverter intake 2028B is replaced by water flowing in through outflow spaces 2097 (see arrows 3 and 4).

As impeller 2003 rotates, water continues to be pushed down and out through diverter intake 2028B (see arrows 5 and 6 of FIG. 9B). In addition, the water pushed down and out substantially vertically through diverter intake 2028B continues to be replaced in cavity A by water flowing in through outflow spaces 2097 (see arrows 7 and 8 of FIG. 9B). Of note, due to the water being pushed down and out substantially vertically through diverter intake 2028B, the entire water circulator 2001 moves up relative to the waterline W (due to equal and opposite reaction). This movement is seen at arrow 9 of FIG. 9B (as well as in the lowering of the waterline W relative to water circulator 2001),

Next, at time T₁ (which occurs after time T₀) the water circulator 2001 moves up sufficiently high to bring outflow lip 2080 above the waterline W (see FIG. 9C). In one example, the time period between T₀ and T₁ is 0.15 seconds.

Once time T₁ is reached, air is ingested into cavity A (see arrows 10 and 11 of FIG. 9C) and the impeller 2003 loses its prime. A short time thereafter, at time T₂, the water circulator 2001 falls back down relative to the waterline W (see arrow 12 of FIG. 9D) and the outflow spaces 2097 ingest water (see arrows 13 and 14 of FIG. 9D). The heel of water and the previously ingested air are then whipped into a froth by the rotating impeller 2003 (which has continued rotating in a single direction (e.g., clockwise) since time T₀). In an embodiment, when flow reciprocates, the fill level of the water circulator changes up and down and the lowest level of the water in the water circulator is the heel of water.

A period of time thereafter, at time T₃, the water flow reverses such that higher density water from outside the water circulator 2001 is forced up substantially vertically through the diverter intake 2028B (see arrows 15 and 16 of FIG. 9E), cavity A fills with water, and the water in cavity A then exits via the outflow spaces 2097 (see arrows 17 and 18 of FIG. 9E). The water reverses flow because the water outside the water circulator 2001 is at a relatively higher pressure due to the presence inside the water circulator 2001 of the lower density froth.

Still referring to FIG. 9E, it is noted that the gas-free water (see arrows 15 and 16 of FIG. 9E) flows past the impeller 2003 the “wrong way”, causing intense cavitation (and shear) just above the tip of the impeller 2003. Finally, at time T₄, the impeller 2003 regains prime and water flow is down and out again (see FIGS. 9A and 9B). The process then repeats (through FIGS. 9C-9E). In one specific example, the process cycles every 6 seconds.

Even though the downflow water (9B) is only for 0.15 seconds out of 6 seconds, considerable water is transferred down.

7 MGD*(0.15 seconds/6 seconds)=0.175 MGD

The downflowing water transfers seed crystals and soluble BOD down into the anaerobic zone at the base of the water column. We have found that a 2:1 safety factor is most effective. For example, a 1.9 MGD 2lagoon system requires a 2-3× safety factor.
a. Jacksonville NC Safety Factor=21 BFs*0.175 MGD/1.9 MGD=1.9
b. A 1.85 MGD system has a safety factor of 2.3
   i. WRP4 Safety factor=24*0.175/1.85 MGD=2.3

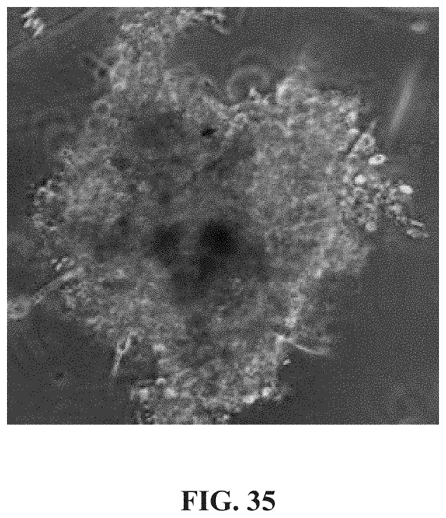

What is actually happening is that soluble BOD (SBOD), influent TSS and produced seed crystals are sent into the anaerobic zone “twice”. The gas formers consume the SBOD directly without spending energy and DO to first convert SBOD into TSS. The seed crystals form granule spheres (FIG. 35) that roll across the entire flat. TSS is hydrolyzed into SBOD and turned into gas in the anaerobic zone.

Design Concepts are:

1. Using a safety factor of 2, determine the minimum level of BFs needed

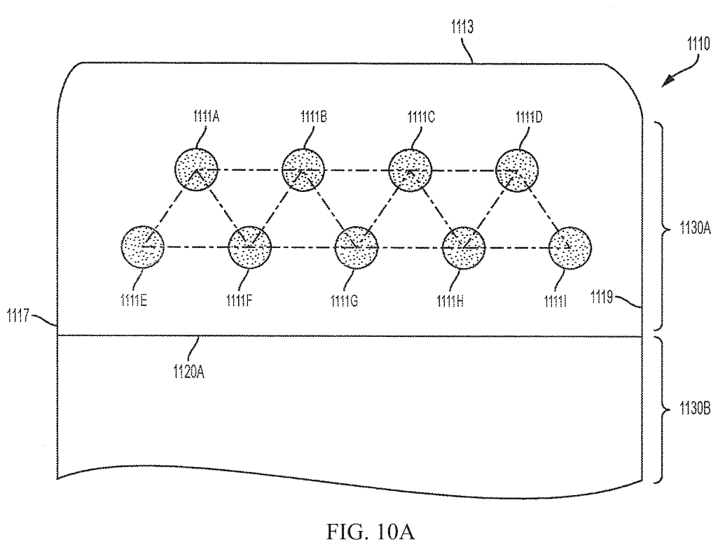

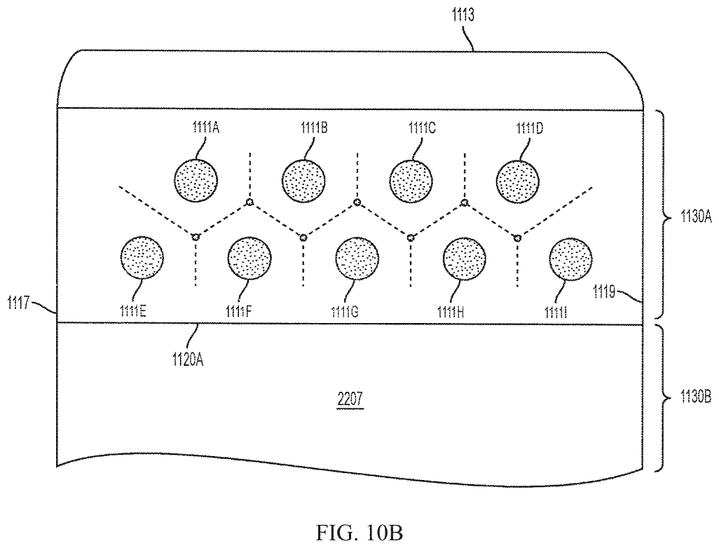

2. Make sure the cluster reaches from berm-to-berm (FIG. 10B)

3. Calculate the HRT (hydraulic residence time) over the pond flat (volume/flow) an insure that HRT>7 days . . . if not, then more BFs may be needed.

In practice there may be extra cavitating circulators. If Volatile Fatty Acids (VFA; Short-chain fatty acids, also referred to as volatile fatty acids, are fatty acids with less than six carbon atoms) odors are perceived, the flow in a circulator may be reversed (to non-cavitating). This reversal of flow is continued in other circulators until the VFA odor is gone (e.g., overnight). For example, in the circumstances where there are initially 4 BFs (cavitating) on the circle, but there are VFA odors. The direction of rotation of the impeller of, for example, one water circulator is reversed and is run in the reverse direction for a day overnight. The next morning, the presence of a VFA odor is monitored. If the odor remains, the direction of rotation of the impeller of, for example, water circulator at the opposite end of the circle is reversed. In almost all circumstances, the VSA odor dissipates. The ideal configuration in this example then is 2 diagonal circulators rotating clockwise and the other two rotating counterclockwise. The hydraulic corners remain at 90° to insure that the maximum number of granules are produced. Later, the sludge inventory is digested, so there are excess granules. The process may then be then reversed and in an embodiment, optionally one of the non-cavitating circulators can be changed to cavitating to increase enzyme production. This may be accomplished, for example, by a reversing switch on the control panel of each water circulator. Thus, the methodology not only reduces or eliminates waste but also reduces or eliminates odor. Wastewater solids are often defined as volatile solids (VS) or non-volatile solids (NVS). Volatile solids are those solids in water or other liquids that are lost on ignition of dry solids at 1,020° F. (550° C.). Non-volatile solids are the residue after the heating.

In an embodiment, there can be other circulator(s) not in the disclosed configuration. In an embodiment, there is at least one cluster having the circular configuration.

Referring now to FIG. 10A, FIG. 10A illustrates examples of circulator configurations. In FIG. 10A certain details relating to water circulators 1111A-1111I of FIGS. 9A-9E are shown (also shown in FIG. 10A are portions of second lagoon 1110 including influent side 1113, first berm 1117, second berm 1119 and first baffle 1120A).

As seen in FIG. 10A, clusters of three water circulators form equilateral triangle configurations. For example, water circulators 1111A, 1111E and 1111F comprise vertices that form a first equilateral triangle (see the dotted lines in the figure connecting these water circulators). Further, water circulators 1111A, 1111B and 1111F comprise vertices that form a second equilateral triangle (see the dotted lines in the figure connecting these water circulators). Further still, water circulators 1111B, 1111F and 1111G comprise vertices that form a third equilateral triangle (see the dotted lines in the figure connecting these water circulators). Of course, the remaining water circulators shown in FIG. 10A form similar equilateral triangles. In addition, it is noted that various equilateral triangles may be formed using a given water circulator more than one time (that is, a given water circulator may be shared by a plurality of clusters, in this case, triangles). In one specific example, the center-to-center distance between the water circulators in FIG. 10A (that is, the length of one of the sides of a given one of the equilateral triangles) is 30 feet. Skilled artisans recognize that equilateral triangles are geometrically equivalent to 3 circulators equidistant around an imaginary center. In other embodiments, water circulators in clusters may be in configurations other than equilateral triangles. For example, they may form any type of triangle, such as acute triangle, obtuse triangle or a right triangle. In other examples, they may form any other desired geometric shape.

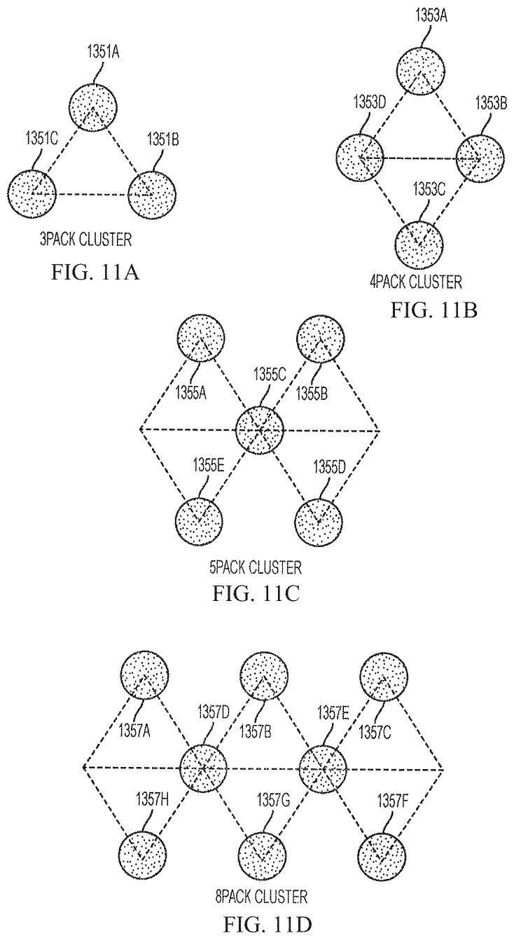

Referring now to FIG. 10B, certain details relating to water circulators 1111A-1111I of FIG. 11 are shown (also shown in FIG. 10B are portions of second lagoon 1110 including influent side 1113, first berm 1117, second berm 1119 and first baffle 1120A).

As seen in FIG. 10B, in operation the water circulators 1111A-1111I form a number of hydraulic walls (shown in this FIG. 10B as dashed lines) and a number of hydraulic corners (shown in this FIG. 10B as dots where the dashed lines intersect). These hydraulic walls and hydraulic corners of the configuration shown in FIG. 10B may operate as described elsewhere herein.

Also shown in FIG. 10B, some circulators are open to one direction, such as circulator 1111H, while others are open to two directions, such as 1111I.

Referring now to FIGS. 11A-11D, illustrated are schematic plan views of various arrangements of water circulators according to embodiments of the present disclosure. More particularly, as seen, in FIG. 11A an equilateral triangle three-pack cluster may be formed of water circulators 1351A-1351C. As seen in FIG. 11B a double equilateral triangle four-pack cluster may be formed of water circulators 1353A-1353D. As further shown in FIG. 11C, a five-pack cluster may be formed of water circulators 1355A-1355E. As can be seen in FIG. 11D, an eight-pack cluster may be formed of water circulators 1357A-1357H.

Although only clusters up to an eight-pack are shown in FIGS. 11A-11D, the packs of circulators can increase by any number, including by multiples of three as three circulators were added to change FIG. 11C to FIG. 11D. For example, other embodiments can include clusters of 11 circulators, 14 circulators, 17 circulators, etc. Further, although the triangles referred to in FIGS. 11A-11D are equilateral, in other embodiments, other shaped triangles, such as isosceles triangles may be formed. Also, lengths between circulators in, for example FIG. 11D, can be in the range of about 30 feet to about 200 feet, about 40 feet to about 150 feet, about 50 feet to about 125 ft, about 60 feet to about 100 feet, about 70 feet to about 95 feet, about 80 feet to about 90 feet, or about 88 feet. These distances can be between circulators on the same “line” such as in FIG. 11D, the distance between circulator 1357A and 1357B, and can also be distances between circulators on opposing ends of the cluster, such as in FIG. 11D, the distance between circulator 1357A and 1357H.

In an embodiment, in a group of circulators, if the largest distance between any adjacent circulator of the group of circulators is 200 ft or less, it is considered a single cluster. In a group of circulators, if the largest distance between any adjacent circulator of the group of circulators is greater than 200 ft, the group of circulators is considered a plurality of clusters, e.g., the circulator which is more than 200 feet from the closest adjacent circulator is not in the same cluster as the other circulators in this group of circulators.

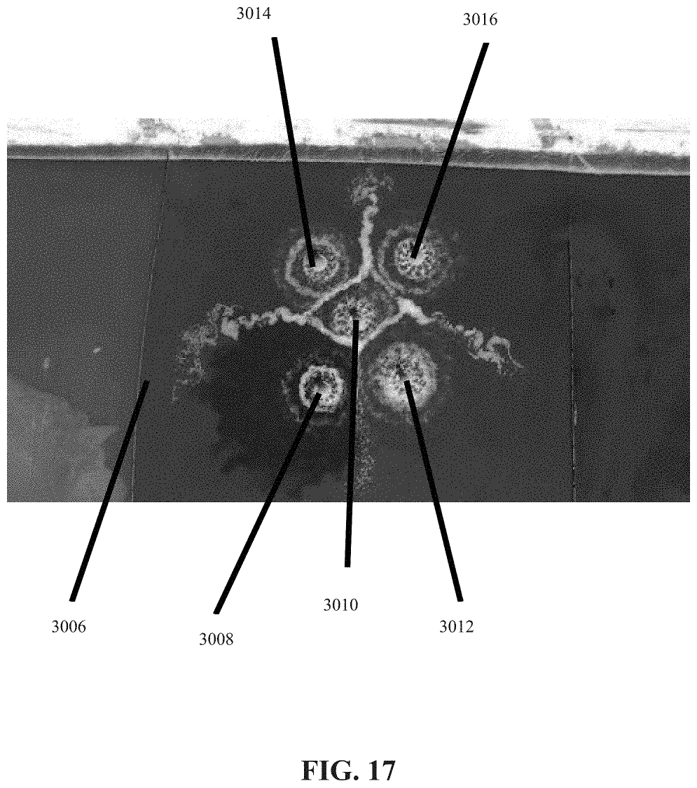

There is an unexpected benefit to clusters of 5, 8, 11, 14 or more. The inscribed diamond around the interior circulator “excavates” the sludge bed inside the diamond, creating a higher concentration of active granules. The perimeter (i.e. 1 or 2 open sides) flow scours the surrounding sludge surface and when flow returns, feeds the granules inside the diamond. The outside circulators make crystals, but these crystals are spread by escaping out the open sides. They form heavy floc, that is floc built around a mineral seed and are aerobic. (This effect can be seen in FIG. 17 (further discussed below), specifically in the lower left corner dark water is seen, which suddenly disappears as heavy floc sinks rapidly below the visible upper water column). The inside-the-diamond floc is anoxic. The net effect is to “recruit” outboard floc and return it to the diamond for conversion to gas, accelerating sludge digestion.

There is another unexpected benefit. As gas is produced inside the diamond, electrolytes accumulate to make a dense, low surface tension “brine”. Low surface tension brine “percolates horizontally” through the remaining sludge blanket. This propagates the hydrolysis-released enzymes horizontally through the sludge blanket. In turn, hydrolyzing enzymes feed gas formers and produce gas. The gas rises to the extent of the horizontal percolation and destabilizes the sludge bed. The now alluvial sludge is scoured back to the diamond reactor zone where it is turned into gas.

The net effect is to create a pocket reactor that is fed by lateral percolation of produced enzymes, unsettled legacy sludge and finally returned to the reactor by perimeter scouring flow.

As described herein, an aspect of the present disclosure is the formation of biologically active granules. It is these granules which help digest the sludge. The more of these granules that are formed, the faster the sludge is removed (digested) from the lagoon.

Without wishing to be bound, it is believed that the biochemistry of sludge digestion and the formation of the biologically active granules proceeds through the following steps.

Waste is converted into living and dead bacteria by aerobic bacteria, producing CO₂. This step is very different for different compounds present in the sludge, as specialized bacteria are needed for specialized compounds (i.e. industrial waste). Dead bacteria are hydrolyzed to simple liquids by extracellular enzymes from facultative bacteria and intracellular enzymes from cell lysing in the cavitation zone. This is a ubiquitous step, since all bacteria have similar element ratios to carbon. Facultative and anaerobic bacteria serially ferment simple liquids into acetic acid (C₂), which lowers the pH in the pond.

Obligate anaerobes convert C₂ into C₁ (methane and carbon dioxide). Acid is consumed, raising the pH in the pond. If the methanogens are part of a biofilm, H₂ production is also minimized. In the presence of Sulfur Reducing Bacteria (SRB), H₂ is converted to H₂S. When H₂ is not formed, SRB remain inactive, thus preventing production of H₂S.

The lagoon containing the sludge not only contains these bacteria, but also calcium and carbonate ions.

Without wishing to be bound, it is believed that cavitation described hereinabove creates such force that it causes the water molecules to break apart into free radicals, hydrogen free radical (.H) and hydroxyl free radical (.OH). It is also believed that the cavitation also causes mineral crystals to nucleate when the solution is supersaturated with calcium. When the pH initially is 7.5 or greater, the calcium ions react with carbonate anions (alkalinity) and calcium carbonate seed crystals are formed. Once the seed crystals are formed, the pH of the lagoon water may vary to as low as 6.2 or as high as 10. Seeds (granule precursors) are discharged at the base of the water column by the downflowing 0.175 GPD (per BF). The seeds grow and propagate. As small seed crystals flow around in perimeter flow, the crystals grow in size and weight until they can also precipitate into the anaerobic zone. Once in the anaerobic zone, the crystals are coated with a gas-forming anaerobic biofilm. As gas forms and occludes to the biofilm-coated crystal, the crystal floats into the facultative zone. Facultative bacteria attached to the biofilm. The facultative bacteria protect the biofilm by consuming toxic oxygen and feed the biofilm by converting solids serially into shorter and shorter fatty acids. C2 fatty acids (acetic acid) and CO₂ (C1) are the primary food of the gas-forming biofilm. The individual granules gradually agglomerate into large crystals that settle and do not fluidize. Immature granules can be fluidized; mature granules sink permanently. Eventually the granular fluidized bed is intermediate between alluvial and gelled sludge. The alluvial sludge and granules are well mixed by produced gas. However, the gelled sludge is not.

With respect to the seeds being discharged at the base of the water column, in an embodiment, the seed outflow is initially at the surface until the seeds hit a hydraulic wall. Without wishing to be bound, it is believed that the hydraulic wall redirects flow down to the bottom. The path of least resistance is under the downward flowing hydraulic corners and thus at the base of the water column. When there is a hydraulic corner, the seeds are concentrated (e.g. in a 4-pack cluster from 4 different water circulators) and thus agglomerate into granules more easily.

Without wishing to be bound, it is believed that once the CO₃⁻, indirectly produced by the granule, reacts with the Ca⁺⁺, thereby stabilizing the gel to form calcium: carboxylic acid ion pairs. The immediate gel collapses to become alluvial sludge (i.e. un-stabilized sludge). The process is iterative over time. The gel layer thins and the granule bed increases. The carbonate extracts Ca⁺⁺ from the sludge gel, destabilizing it. The resultant CaCO₃ is used to increase the size of the granules and form new granules. The bacteria bind the CaCO₃ to the granule with a bacteria-produced glue to increase the size of the granule.

It is believed, without wishing to be bound, that bacteria use the local CaCO₃ as a base on which they form a biopolymer that enlarges the granule. In addition, bacteria bond to other mineral salts, e.g. calcium phosphate and struvite, to form a biofilm which anchors to the granules. The colonizing bacteria form a synergistic biofilm on the heavy mineral. The mineral salts selected for use as granules encourages biofilm formation. The inner bacteria are obligate anaerobes, e.g. Geobacter and Methanosaeta. The outer bacteria are facultative bacteria that hydrolyze bio-solids into bio-liquids. The inner bacteria convert bio-liquids into gas and consume acid, raising pH. The obligate anaerobes in the interior utilize bound-oxygen to produce C₁ (methane) and/or carbon dioxide gases. A superficial coating of facultative bacteria consumes trace free oxygen and extracellular and intracellular enzymes convert biosolids (sludge) into liquid BOD. The facultative granule's exterior hydrolyzes the castings into liquids while the interior converts liquids sequentially into gas and consumes acid. The free radicals and intense jets of hot water (from cavitation bubble collapse) described hereinabove attack the bacterial cell wall and lyse it, releasing intracellular enzymes. Intracellular enzymes are also released by cavitation. The combination of the extracellular enzymes and the intracellular enzymes and intracellular enzymes produced by free radicals digest the sludge. It is well accepted that bacterial activity shows a first order response by slowing when temperatures drop. For example, ammonia oxidation is well known to have a strong dependency with temperature. The nitrification bacteria responsible for ammonia oxidation are practically inactive at temperatures below 5° C.

Surprisingly, the reduction in biochemical oxygen demand (BOD) is independent of ambient temperature when an aerobic vertical surface is combined with horizontal anaerobic granules. BOD is the amount of dissolved oxygen needed by aerobic biological organisms in a body of water to break down organic matter at a specific temperature over a defined period of time.

The alluvial sludge is digested in situ. The granules are dense enough to sink through the alluvial sludge, but they do not penetrate the gel-structured recalcitrant sludge. The alluvial sludge is digested, leaving entering solids and recalcitrant sludge to be digested. The new sludge (i.e. incoming solids, aerobic produced biosolids and fresh worm castings) is alluvial because new biosolids rain down from the quiescent zone above without yet forming a new gel. The granules have capacity to handle this load.

Recalcitrant sludge is difficult to digest because the granules are in intimate contact only on the substantially spherical granule's contact surface area with substantially flat recalcitrant sludge's gelled structure. Only the granule's lower surface, in direct contact with recalcitrant sludge, has the opportunity to digest. Thus, recalcitrant sludge is digested slowly.

In the present disclosure: 1. The cluster(s) and the hydraulic corners create excess enzymes (the cavitation lyses bacterial solids releasing their intracellular enzymes). 2 The enzymes hydrolyze BOTH the incoming solids and the pre-existing solids inventory. 3 Granules grow on the seeds made during cavitation up to the food available (incoming solids+inventory solids). 4. Thus, excess granules are made during inventory removal (excess only after the pre-existing inventory is digested). 5. Once the inventory is gone, the available substrate is only incoming solids. 6. The granules have too little food and thus cannot be rate limiting.

Each cavitating water circulator lyses bacteria and algae. It may be difficult to calculate the degree of this lysing as it is dependent on the cavitation, the moles of bacteria and the moles of algae. To develop a measure for design, the ratio of the circulator flow (# of circulators*flow per circulator) divided by the influent flow is a useful dimensionless ratio. In an embodiment, a dimensionless ratio of the flow rate of the reciprocating water circulator per influent gallons per day ranges from about 0.5 to about 15, about 1 to about 5, about 1.2 to about 3, about 1 to about 2, about 1.4, about 2 to about 15, about 3 to about 11, about 4 to about 9. In a specific example, a ratio with respect to flow rate is 1 reciprocating BF water circulator/0.3 Million Gallons Per Day=6.7 [6.7=1 circulator*2 MGD per circulator/0.3 MGD influent].
Table 1 below provides examples of ratios.

TABLE 1

| # of | Flow per circulator | Influent flow | |
|---|---|---|---|
| circulators | (MGD) | (MGD) | Ratio |
| 1 | 2 | 0.3 | 6.67 |
| 3 | 2 | 0.7 | 8.57 |
| 4 | 2 | 1 | 8 |
| 1 | 2 | 0.6 | 3.33 |
| 1 | 2 | 0.5 | 4 |
| 2 | 2 | 0.8 | 5 |
| 4 | 2 | 0.8 | 10 |
| 8 | 2 | 35 | 0.46 |
| 16 | 2 | 35 | 0.91 |
| 24 | 2 | 35 | 1.37 |
| 32 | 2 | 35 | 1.83 |

An advantage of the present arrangement is that these granules are concentrated in the center of the circle of the circulators, making the granules more concentrated in one area, thereby making the sludge digestion more effective by mechanically breaking through the recalcitrant gel. Once gas is produced below the gel, the rising produced gas destabilizes the gel, making it alluvial. As the destabilization expands from the hydraulic corners, the recalcitrant gel breaks down and is readily digested.

In one specific example, the lagoon is at least four feet deep (with an anaerobic bottom and with essentially no limit on the maximum depth). in another specific example, the lagoon is at least seven feet deep (with an anaerobic bottom and with essentially no limit on the maximum depth).

In another example, there are two CaCO₃ formation strategies: The first is pH>7.5 to initiate granule formation (this may only need to happen once). The second reaction takes place at the produced gas/supernatant interface where CaCO₃ can be made at a pH less than the above pH wherein CO₂ gas reacts with calcium in the bubble-surrounding water (e.g. pH=6.5).

As described herein, in various examples lagoon granules: (1) are biologically active; (2) produce CH₄, CO₂ and H₂O (not H₂S); (3) self initiate and self propagate.

Further, as described herein, in various examples disclosed mechanisms: (1) operate best at cold temperatures (e.g., T<25° C.); (2) provide reciprocating flow past a constantly turning impeller; (3) use water having a pH greater than or equal to 7.5 one time only; (4) provide small granules (immature) that are fluidized (mature granules are not fluidized); (5) provide granules that do not wash out, but can cement-in in high calcium/high pH environments; (6) provide granules that are in reduced surface tension hydrolytic brine.

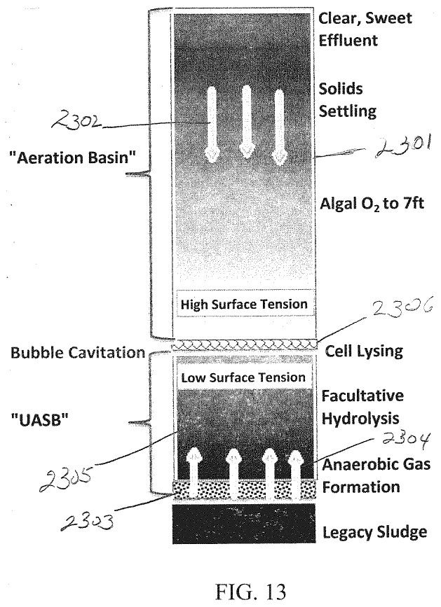

Without wishing to be bound and referring to FIG. 13, there is a quiescent or gently mixed aerated zone (2301)(DO>1 mg/l) where SBOD is converted into TSS. TSS settles 2302 (downward arrows). The surface tension of this water is close to pure water. (For example, in one embodiment: 69.17 mN/m (pure water is 72 mN/m)). The dots (2303) represent the gas-forming mature granules that are biologically active but do not fluidize. The upward arrows (2304) show the rising gas. The low surface tension zone (2305) is a facultative fluidized zone where immature granules are lifted up by occluded produced gas until the gas is released at the aerobic/facultative interface (high surface tension/low surface tension) and the immature granules fall. The surface tension of the fluidized bed is low, 44.98 mN/m in one embodiment (FIG. 10A embodiment). The reason surface tension is low is facultative bacteria convert solids first into long chain fatty acids (soap).

The interface between high and low surface tension (2306) is shown in FIG. 13. In an embodiment, it is about 3 inches thick. Internal bubble pressure is directly proportional to surface tension. Thus, the upper part of the interface has small volume, high-pressure bubbles. The lower part of the interface has large volume, low-pressure bubbles. As an individual bubble transitions through large bubble/low surface tension and then into small bubble/high surface tension water, it is believed that the bubble geometry is inherently unstable (big on the bottom, small on top). The large-then-small-then-large cycle repeats itself until cylindrical biological solids passing through this violent zone are physically ripped asunder, releasing internal electrolytes, carbohydrates and cell fragments. This imbalance causes each bubble to cavitate.

As TSS rains down from above, each intact bacterial cell is torn apart by the cavitating bubbles, reducing solids mass as internal water is released. For example, about 80% of the cell mass is water, 18% is substrate (sugars, enzymes, electrolytes, etc.) and 2% is non-digestible ash. The released digestive enzymes accelerate biological hydrolysis in the fluidized bed. For perspective, the COD in the high surface tension aerobic zone is 225 mg/l; the COD in the low surface tension facultative zone is 40,000 mg/l. This large swing in 3″ of vertical travel is unheard of in a quiescent water column.

There is a critical mass of cell lysing that has to occur to insure that solids mass hydrolysis is greater than solids mass accumulation. Gas from a critical mass of granules provides sufficient gas to lyse virtually all the intact cells that rain down through the low/high surface tension interface. Legacy (ancient) sludge is gradually converted into gas at the sludge/mature-granule interface. The default position is sludge accumulates because there is insufficient hydrolysis.

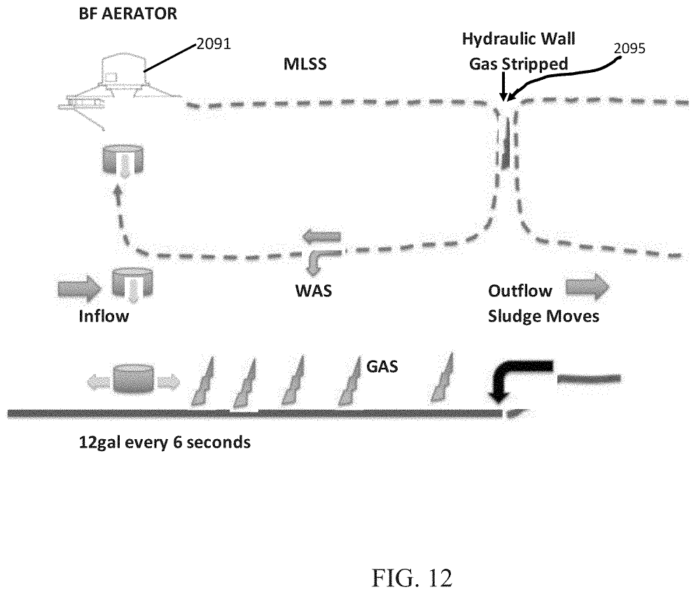

Referring now to FIG. 12, an embodiment is shown in which a water circulator 2091, and although not shown, another circulator to the right and equidistant from the hydraulic wall, cooperate to produce hydraulic wall 2095. In this embodiment, the hydraulic wall 2095 functions as one of the partial depth baffles described herein, resulting in the aerobic, quiescent settling and anaerobic zones shown in FIG. 12. Also resulting from the hydraulic wall 2095 is the perimeter water flow shown in FIG. 12. In FIG. 12, the blue cylinders represent the 12 gallons per 6 seconds of reverse flow (0.175 MGD). This carries mineral crystals directly down to the anaerobic zone at the bottom of the water column.

The following examples are meant to illustrate the present invention but are non-limiting.

### EXAMPLE 1

In this example, the lagoon is a large flow lagoon, such as, for example, paper mill lagoons. There is a difference between lagoons with ≤3 MGD (low flow) and flows of about >10 MGD, >15M MGD, >20 MGD, about >25 MGD, about >30 MGD, about >35 or about >40 MGD (high flow). In low flow lagoons, sludge builds up at the inlet to the first pond. In high flow ponds, flow forms areas of flow and areas of built up sludge and other particulates, referred to herein as “sand bars”.

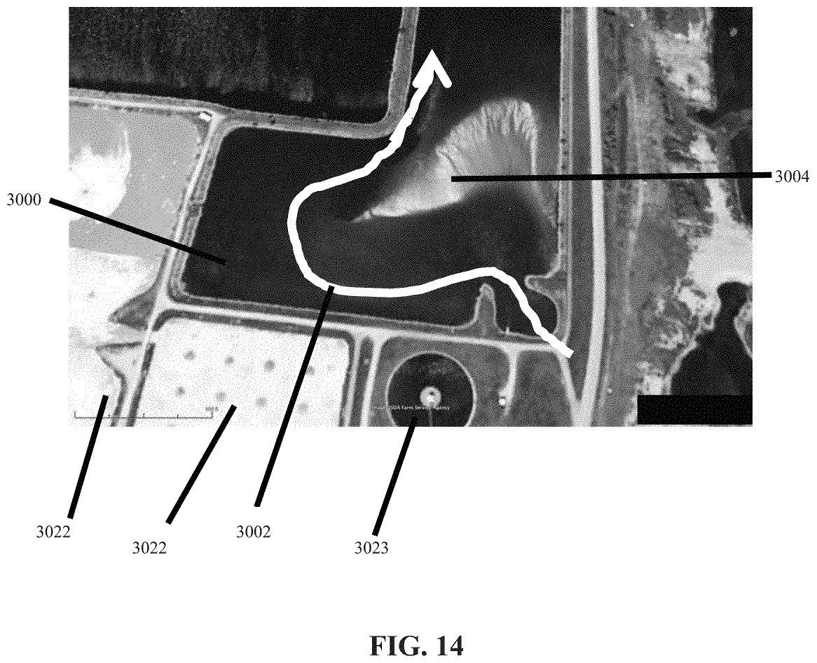

In regards to paper mill lagoons, paper mill waste is slow to settle because fast settling solids are typically first removed in a clarifier or a “wide spot” in the process flow. Thus, slow settling solids form sand bars on the inside of flow curves. As shown in FIG. 14, which is an overhead photograph of a lagoon 3000, white arrow 3002 has been added to the photograph indicate a channel of flow from a lagoon inlet, with a lighter area of the lagoon 3000 indicating an area of a sandbar 3004.

In this picture, about 3,500 hp of splasher aerators 3022 are shown, which can be used to pretreat any inflow. However, aerators of higher and lower horse power can be utilized. For example, they may range from about 1,00 horsepower to about 4,000 horsepower. As another option, a clarifier 3023 can be placed between aerators 3022 and lagoon 3000.

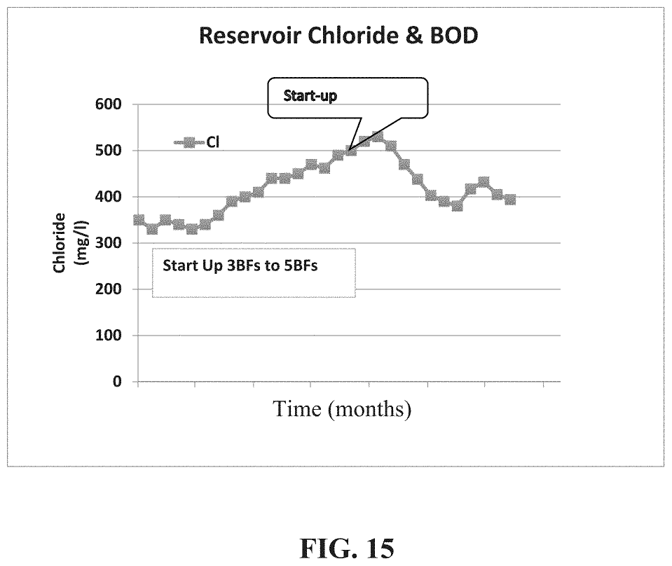

In high flow systems with extensive channeling, fast flowing eddies disrupt the separation into discrete zones. In this type of system, a group of five circulators a “5-pack”, such as shown in FIG. 11C has a surprising effect on the salt content of surface water. After the 5-pack start-up, chlorides began a linear decline, as illustrated in FIG. 15. In FIG. 15, each line on the x axis represents a month interval.

This reduction in chlorides is likely due to light floc being converted to “heavy floc” (bacterial floc with a mineral core”) and sinking. Each floc consumes some electrolytes and electrolytes were transferred away from the surface by sinking solids. Dissolved Oxygen dropped at first, and then recovered. This likely occurred because sinking floc removed oxygen consumers, clarified the surface and wave-produced DO stayed in the top of the water column.

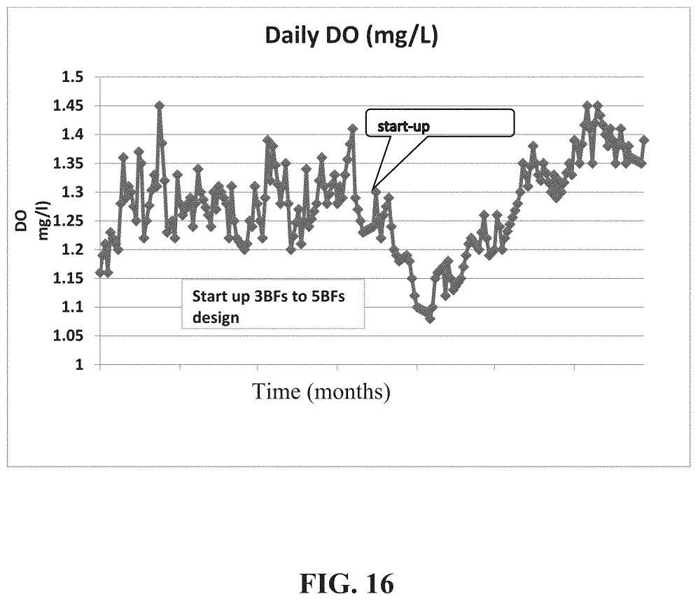

The levels of dissolved oxygen are shown in FIG. 16, with the start up date being the same as that of FIG. 15. In FIG. 16, each line on the x axis represents a month interval.

FIG. 17 is an overhead photograph of a second lagoon 3006, containing five blue frog circulators (3008, 3010, 3012, 3014 and 3016) as discussed above. The distance between circulators can be modified. In FIG. 17 the distance between circulator 3008 and circulator 3012 is about 88 feet, and the distance between circulator 3008 and circulator 3014 is about 88 feet. But, in other embodiments, distances between circulators can be in the range of about 30 feet to about 200 feet, about 40 feet to about 150 feet, about 50 feet to about 12.5 ft, about 60 feet to about 100 feet, about 70 feet to about 95 feet or about 80 feet to about 90 feet.

This pattern shown in FIG. 17 can also be referred to as an inscribed diamond. This pattern forms the vehicle for pushing heavy floc down towards the bottom of the lagoon, also forming oxic and anoxic vertical layering in the water column, digesting sludge in situ, allowing TSS to settle out and thus reducing effluent TSS.

The white lines of soap bubbles in FIG. 17 illustrate where hydraulic walls are formed by the output from each of the circulators, with circulator 3010 being surrounded by hydraulic walls.

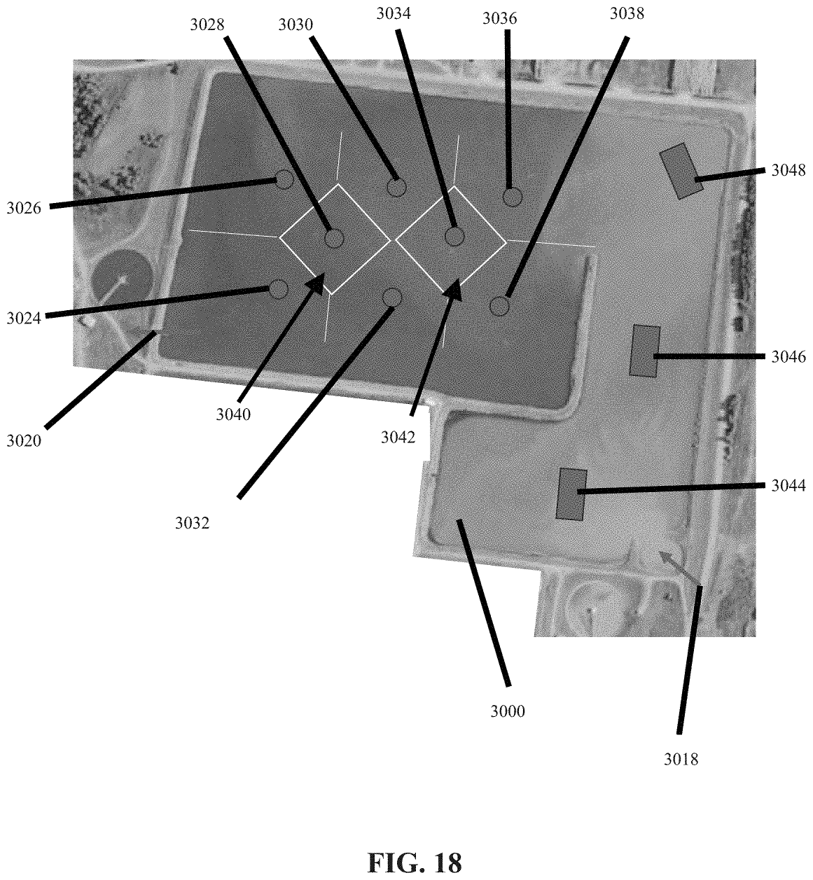

In FIG. 18, an overhead photograph of the lagoon 3000 is shown, taken at a different time from the image in FIG. 14, but of the same lagoon.

In lagoon 3000, influent enters at arrow 3018, passes through lagoon 300 and exits as effluent at arrow 3020. While in the lagoon, solids build up, reducing treatment time causing flow to meander through the pond, further reducing detention time.

Although not to scale, an 8-pack of eight Blue Frog circulators (3024, 3026, 3028, 3030, 3032 3034, 3036 and 3038) are in the lagoon 3000 in a configuration similar to that of FIG. 11D. Not shown in FIG. 18, but in other embodiments, other singular circulators, or other groups of two or more circulators can be placed at any suitable location within the lagoon 3000, as desired.

In FIG. 18 the distance between circulator 3024 and circulator 3026 is about 88 feet, the distance between circulator 3024 and circulator 3032 is about 88 feet and the distance between circulator 3032 and circulator 3038 is about 88 feet. But, in other embodiments, distances between circulators can be in the range of about 30 feet to about 200 feet, about 40 feet to about 150 feet, about 50 feet to about 125 ft, about 60 feet to about 100 feet, about 70 feet to about 95 feet or about 80 feet to about 90 feet.

In FIG. 18, circulator 3028 is essentially a center of a circle, with circulators 3026, 3030, 3032 and 3024 located substantially on a circumference of the circle and, with each circulator3026, 3030, 3032. and 3024 located substantially equidistant, along the circumference of the circle, from each adjacent one of the other water circulators.

The straight white lines of FIG. 18 are illustrated hydraulic walls formed by flows from the circulators, which partially or fully surround circulators 3028 and 3034. Without wishing to be bound, the optional upstream aerators (3022 of FIG. 14) chemically convert non-biodegradable paper compounds into biodegradable compounds and then provide oxygen for heterotrophs to convert SBOD into cell solids. Water and cell solids are fed into clarifier 3023 to remove heavy solids. Light solids and water move into the lagoon 3000. In the lagoon 3000, water finds the path of least resistance. On the inside of any turns, velocities slow and light solids settle into sand bars (seen as lighter areas of lagoon 3000). Over time, light solids compact and become high solids sludge.

The two inscribed diamonds 3040 and 3042 drag heavy floc down to the bottom of lagoon 3000 where it is turned into gas and can also remove other floc and sludge from a sand bar. This creates a diamond-shaped “hole” in the enclosed digester. The force of the hydraulic walls is increased in the diamond because the down-flow does not allow crystal escape. Thus, the entire cross section of the diamond becomes a “reactive hole”. The hole is hydraulically lower than the surrounding sludge bed, and solids flow to the hole rather than away from the hole,

Gassy sludge has an angle of repose of about 4.7°. Non-gassy sludge (recalcitrant gel) has an angle of repose that can approach vertical. The “corners”, such as the corner formed around digester 3024, have two open sides. Flow and heavy floc spread out and then return to the circulator.

When the floc settles, the angle of repose is about 5°. Floc flows downhill into the “hole” formed in a sand bar and is converted into gas. Meanwhile, biochemical hydrolytic enzymes accumulate in the hole as a result of on-going hydrolysis and then percolate laterally across the pond (i.e. entropy (concentration difference) driving force). Over time, the circulators expand the hole from the bottom by hydrolyzing legacy solids.

Thus, the inscribed diamonds net effect is to create a digestion center in the middle of the sand bar. In some embodiments, circulators 3028 and 3034 can be arranged to be directly over a sand bar, in other embodiments, these circulators can be adjacent a sand bar, or can straddle a sand bar. Also, during operation, each of the circulators (3024, 3026, 3028, 3030, 3032, 3034, 3036 and 3038) can be moved at any time relative to each other and also relative to any previous placement in the lagoon 3000.

Further, in this example, eight circulators (3024, 3026, 3028, 3030, 3032 3034, 3036 and 3038) are shown, but in other embodiments, five circulators, 11 circulators, 14 circulators, 17 circulators, etc. can be included in each grouping of circulators.

Rectangles 3044, 3046 and 3048 are symbols of other 8-packs of circulators (or other 5-packs, 11-packs, 14-packs, 17-packs, etc.), and are shown as rectangles for ease of illustration. As with the circulators described above, these packs of circulators can be arranged in any suitable way with regards to flow directions, and can be placed over sand bars, if desired. In some embodiments, rectangles 3044, 3046 and 3048 are in fluid communication with each other and/or the 8-pack of circulators described above, and in other embodiments there is little or no fluid communication between packs of circulators.

In an embodiment, the sandbar may contain at least one of the packs of circulators comprised of 5, 8, 11, 14 or 17-pack circulators represented by the rectangles in FIG. 18. in other embodiments, the number of circulators is limited only by the ease of tethering “daisy chains” of circulators in a line, such that more than 17 circulators can be included in one pack. In an embodiment, these packs of circulators represented by the rectangles are placed on separated sides of the sandbar, In an embodiment, the circulator pack is comprised of 5, 8 or 11 circulators, while in another embodiment, the circulator pack is comprised of 5 or 8 circulators. In another embodiment, the sand bar contains at least 3 of these packs represented by the rectangle, wherein two of the packs are on dispersed zones of the sandbar and the remainder is in-between. For example, if there are three such packs, two are on opposite ends and the third is in the middle. These packs of circulators are distanced close enough together to jointly create enough holes in the sandbar to dismantle it. However, they may be distanced far enough apart to avoid overlap. Skilled artisans will recognize that separation can vary dependent on the age of the pond. About 100 ft spacing to about 1,000 ft spacing is a typical range with about 500 ft spacing being about an average value.

### EXAMPLE 2

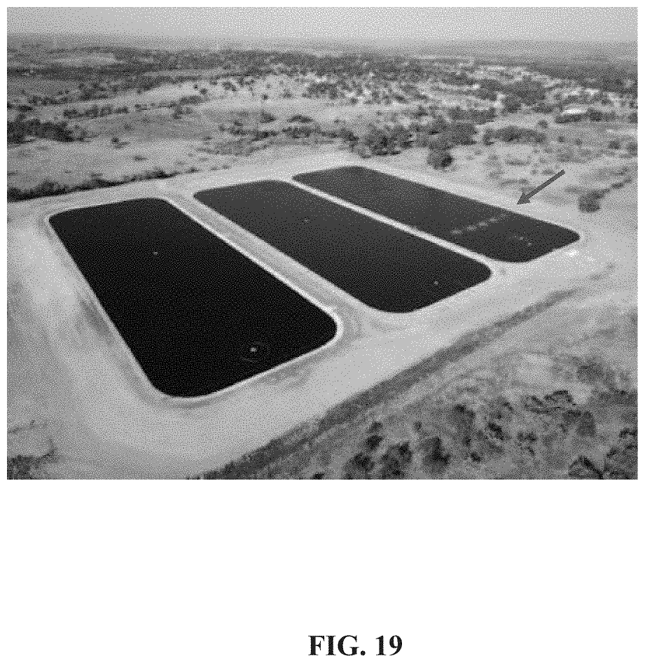

In this example, five circulators are shown in FIG. 19, indicated by the arrow, and are arranged transversely across a pond for treating wastewater. Each of the five circulators are a circulator as shown in FIG. 3C and each have 17 spokes supporting a growth media in this example. The growth media supports microalgae, nitrifiers and worm growth.

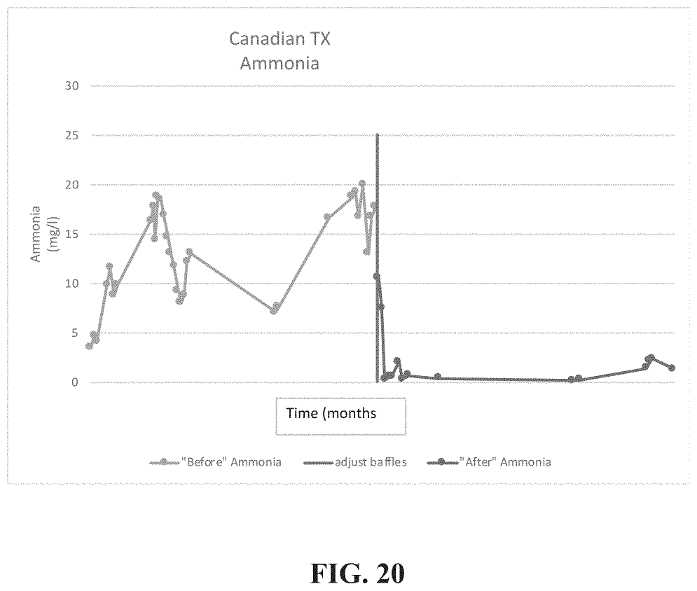

In FIG. 19, the horizontal outflow vectors of each circulator are equal and opposite between adjacent circulators. Ammonia levels altered by this line of circulators is shown in FIG. 20.

Originally, the line of circulators shown in FIG. 19 was installed with a downstream cross-pond baffle to prevent downstream flow. The baffle was then removed, as indicated by the blue vertical line of FIG. 20. There was an unexpected step change to very low ammonia in the effluent after this change. The long periods of time without data points is due to periods of time with no discharge from the pond. An explanation of the data illustrated in FIG. 20 is below.

Nitrifiers grow on attached growth surfaces (like the growth media supported by the spokes of each circulator in the 5 pack straight line (not clusters) of FIG. 19). Small microalgae are a natural, attached growth surface, providing smaller attached nitrifiers with dissolved oxygen (DO), shade and diurnal transport up and down the water column (to a max depth of about 7 ft).

What was unrecognized in the art is the effect of hydraulic walls, from adjacent circulators, on effluent ammonia. These hydraulic walls are discussed above in reference to Example 1.

Microalgae and nitrifiers have a synergistic bond. Worm movement, and other mechanical disruptions, on traditional static attached growth surfaces and media can dislodge the microalgae/nitrifier pair. Hydraulic walls force the pairs to travel linearly away from the circulator (in this embodiment ±300 ft), greatly extending the hydraulic retention time upstream and downstream of the circulator as well as vertically. With a greater retention time, slow growing nitrifiers have sufficient time to remove ammonia, as seen in the data of FIG. 20 after the vertical blue line.

### EXAMPLE 3

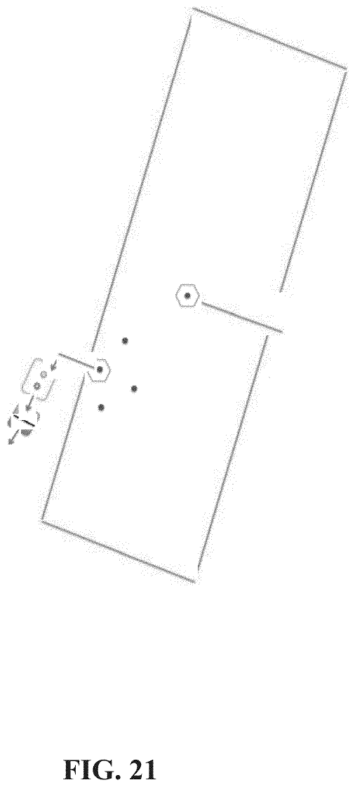

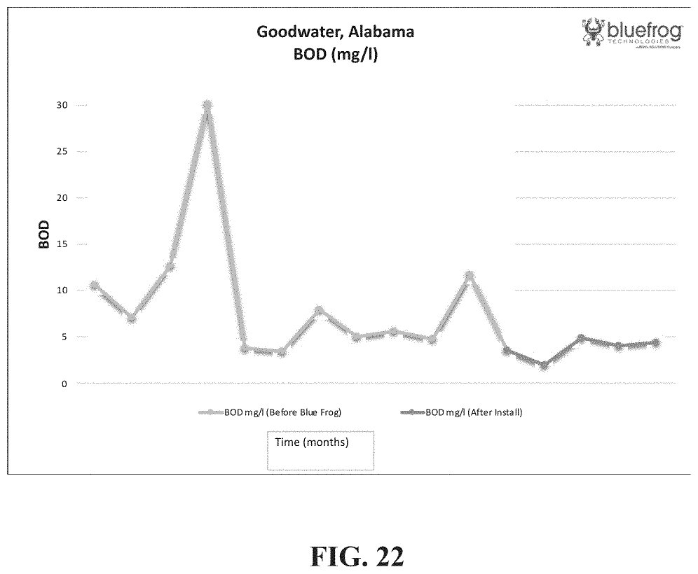

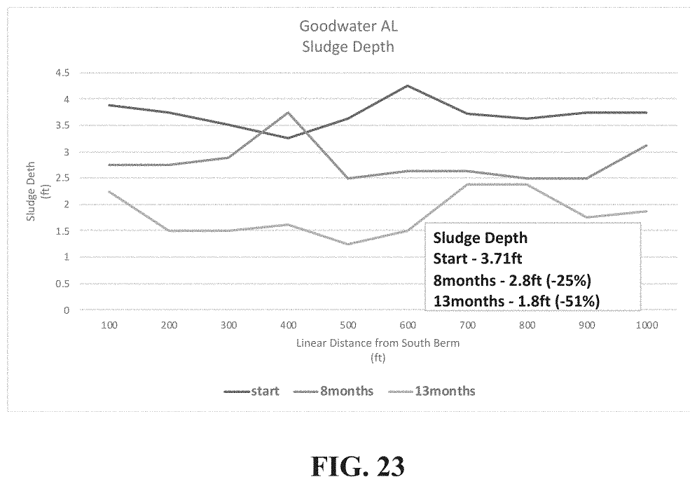

FIG. 11A illustrates a three-pack cluster of circulators, which was added to a central portion of a pond illustrated in FIG. 21. The pond is FIG. 21 is 1,132 ft long. The circulators reduced Biological Oxygen Demand (BOD), and also reduced, surprisingly, sludge across the entire flat bottom of the pond. The cluster formed spherical granules that migrate across the entire flat bottom of the pond, which affect BOD and sludge depth, as shown in FIGS. 22 and 23.

FIG. 22. illustrates BOD measurements from before installation of the inventive three pack cluster (yellow line) and after installation of the inventive three pack cluster (blue line).

FIG. 23 illustrates the depth of the sludge across the pond before the inventive three pack cluster was installed (top line), after 7 months (middle line) and after 13 months (bottom line). The sludge depth declined across the entire flat at both measurements. This occurred because the selected spherical granules migrate across the entire flat seeking nutrients.

Thus, the inventive three pack cluster inoculates the pond with granules, and they migrate across the entire pond flat. Therefore, the pond can be inoculated and not treated in its entirety to achieve the desired sludge reduction level. The capital cost and electrical cost can be reduced dramatically with this use of a three-pack cluster.

### EXAMPLE 4

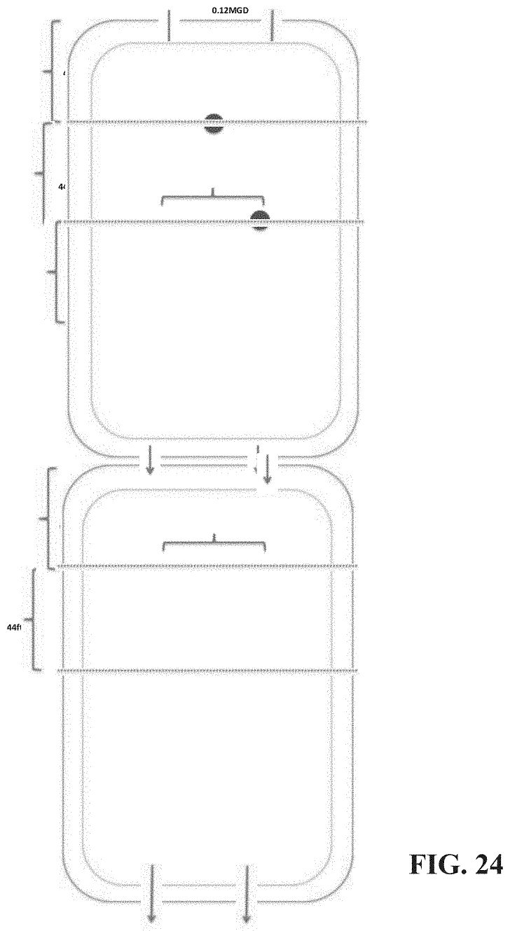

This example is another application of a three-pack cluster (as illustrated in FIG. 11A) in a small flow pond. The use of the three-pack cluster is shown in FIG. 24, which includes two ponds, one flowing into the other, with a three-pack cluster in each pond.

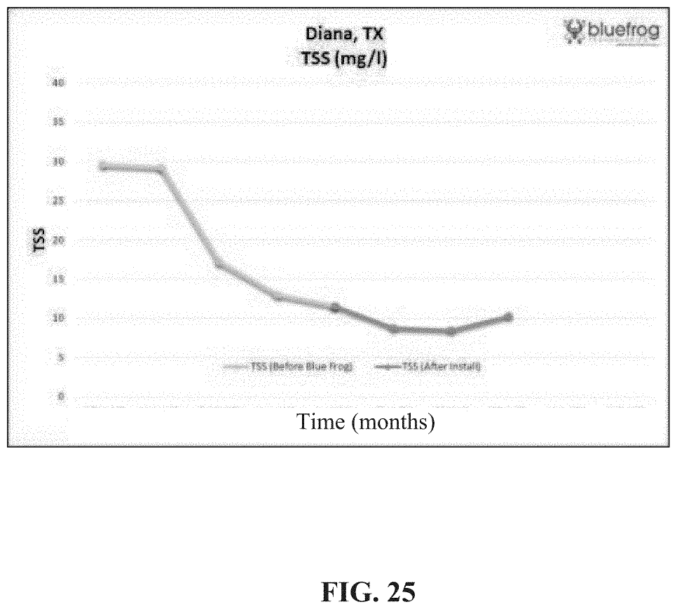

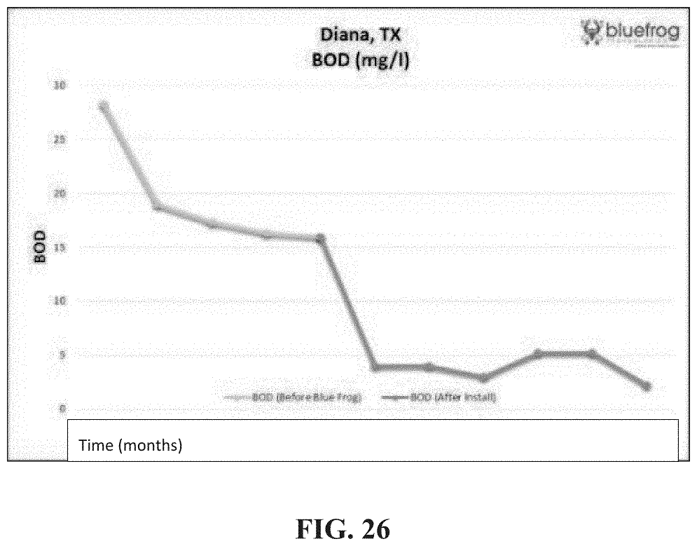

FIG. 25 illustrates total suspended solids (TSS) levels in the small pond over time, with FIG. 26 illustrating biological oxygen demand (BOD) levels in the small pond over time. In each of FIG. 25 and FIG. 26, the yellow line demonstrates the level prior to installation of the three-pack cluster (as shown in FIG. 24), with the blue line demonstrating the level subsequent to the installation of the three-pack cluster (as shown in FIG. 24).

The three-pack cluster illustrated in FIG. 24 selects for granules that roll across the pond flat, cleaning water and removing suspended solids. Near the effluent of each pond, there is a quiescent settling zone. Heavy floc (from the mineral crystal) settles rapidly, reducing TSS.

The results in FIGS. 25 and 26 are remarkable in the reduced BOD and TSS but also in the reduced month-to-month variation. The paragraph 0127 calculation above for this pond is: 6BFs*0.175 MGD downflow/0.12 MGD pond flow−8.75 safety factor [well larger than the 2 to 3 in 0127]. This level of “overkill” was justified because a 3 pack was needed to circulate from lateral-berm-to-lateral-berm (to avoid short circuiting the treatment zone).

This benefit is important because when older sludge is digested, copious amounts of gas are produced. Rising gas can occlude to light solids and lift them up where they leave in the effluent and cause BOD and TSS exceedance.

The three-pack cluster creates a heavy, mineral-based floc that stays settled, eliminating start-up permit-exceedances. This mechanism is also why the floc migrates across the flat bottom surfaces of the ponds.

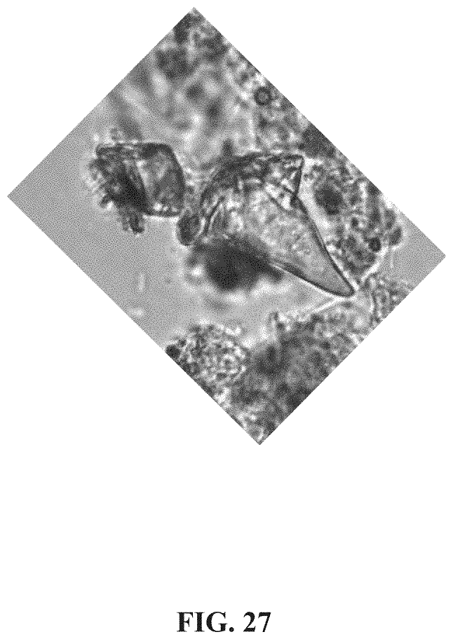

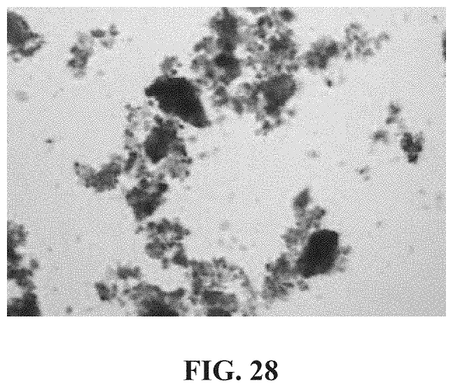

FIG. 27 is a 1,000× photograph of the crystals formed during intentional cavitation. FIG. 28 is a photograph of a similar crystal that is coated with black anerobic, gas-forming biofilm. When facultative bacteria (gray) attach to the black biofilm, the original attachment is asymmetric. Occluded gas lifts the immature granule until the gas escapes. The granule “flies” down to the bottom, moving across the flat, which aids in the reduction of TSS and BOD shown in FIGS. 25 and 26.

In other prior art systems relying on batch flow continuously stirred tank reactors (CSTRs), as crystals are formed and granules grow and migrate, copious gas is formed downstream, occasionally lifting solids into the effluent and exceeding permit allowance.

Including a three-pack cluster of circulators concentrates the granule activity upstream. Although copious gas is still produced, the copious gas is only produced upstream, not downstream. This allows the gas to be released upstream, not downstream and solids settle upstream, away from the effluent. The net effect of the cluster of circulators is to eliminate the start-up year permit exceedance of too much TSS and/or BOD in effluent realized by typical BF CSTR systems.

Eliminating first year exceedance is a major and unexpected difference between the typical system (BF CSTR) and the use of clusters of circulators in this specification.

### EXAMPLE 5

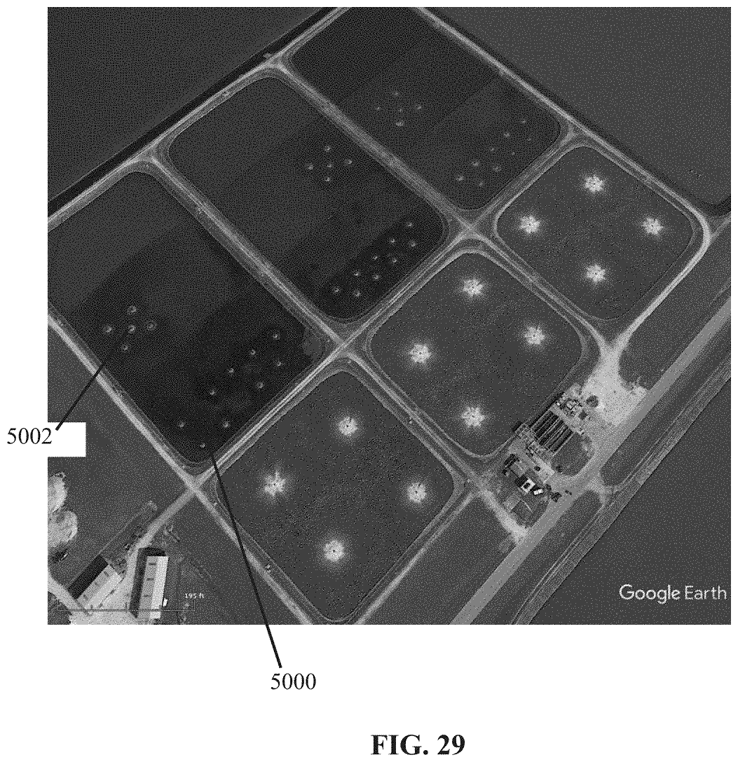

FIG. 29 is an aerial image of three ponds, which each have two sets of circulator clusters 5000 and 5002. The first set of circulator clusters 5000 are in the same orientation as the clusters illustrated in FIG. 10A, the second set of circulator clusters 5002 are in the orientation of FIG. 17.

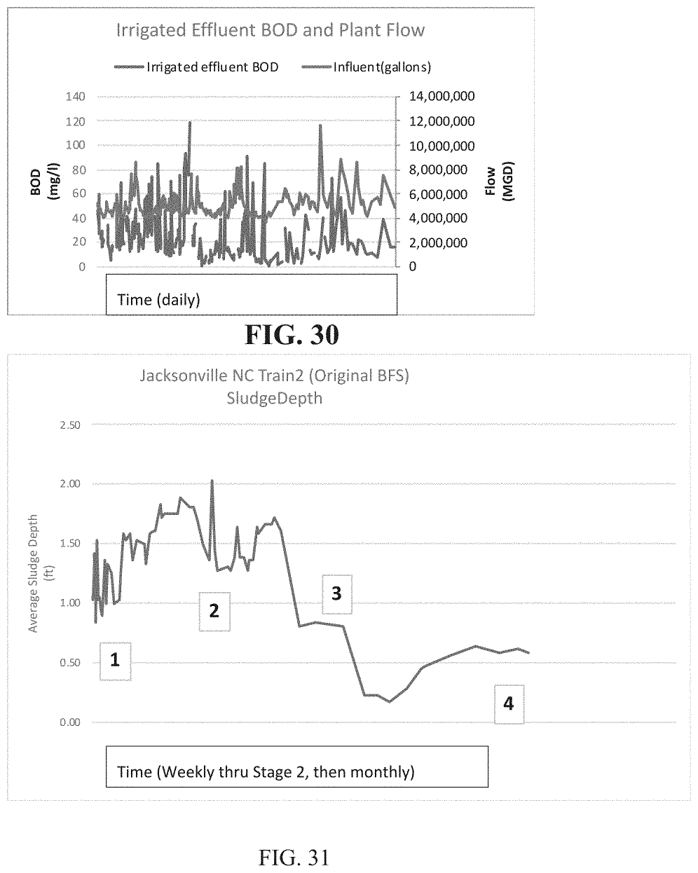

FIGS. 30-33 illustrate various qualities of the results of the system of FIG. 29.

FIG. 30 illustrates both influent flow (top graph) and effluent (bottom graph) BOD levels after the effluent passes through the pond.

The average sludge depth over time of the middle pond of FIG. 29 is shown in FIG. 31. At box 1 (stage 1), sludge volume increases when digestion begins as granules are selected and migrate across the pond flat. Sludge level wobbles up and down but is basically constant for 2 months while granules propagate across the entire pond bottom.

At box 2 (stage 2), leavened sludge is digested from all sides, sludge volume declines as solids are turned into gas. Granules begin to produce copious gas volumes, produced gas lifts high-concentration solids, leavening the sludge blanket, with volume increasing as mass decreases.

At box 3 (stage 3), the concentration of solids decreases, gas escapes, solids sink and measured volume declines rapidly.

At box 4 (stage 4), the volume of sludge oscillates due to seasonal temperature variations, since cold bacteria do not produce much gas and the volume seasonally collapses without continuous leavening. When the weather again warms, increased gas leavens the sludge blanket. Sludge volume stabilizes and steady state is achieved at about 6 inches of sludge.

These stages of sludge are further discussed below:

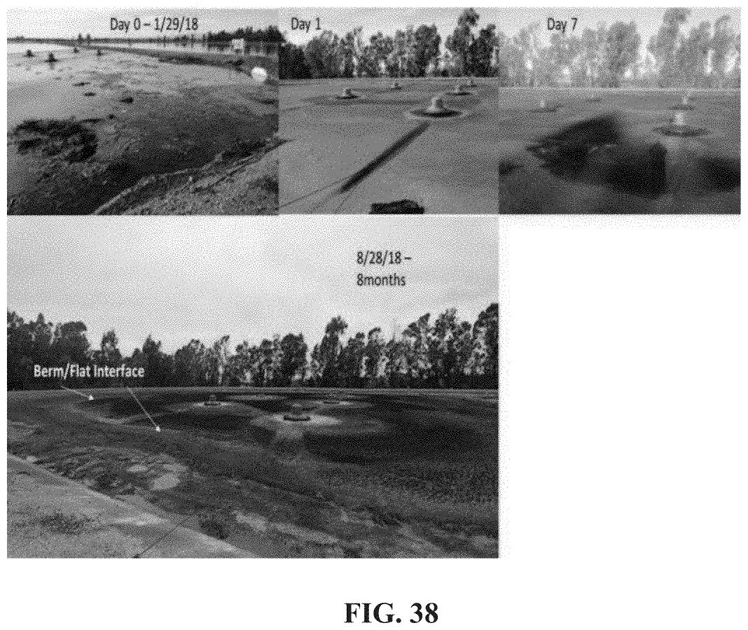

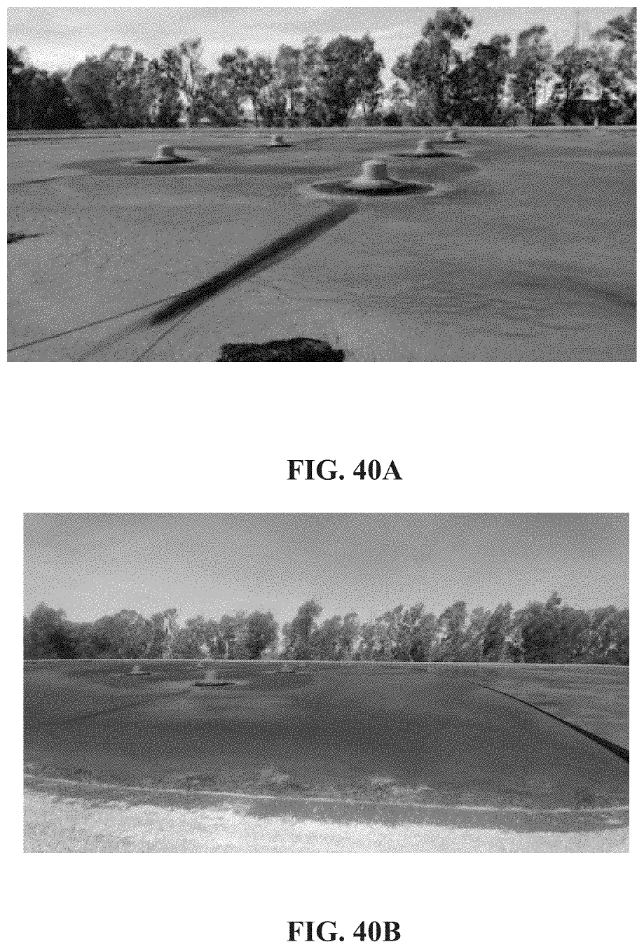

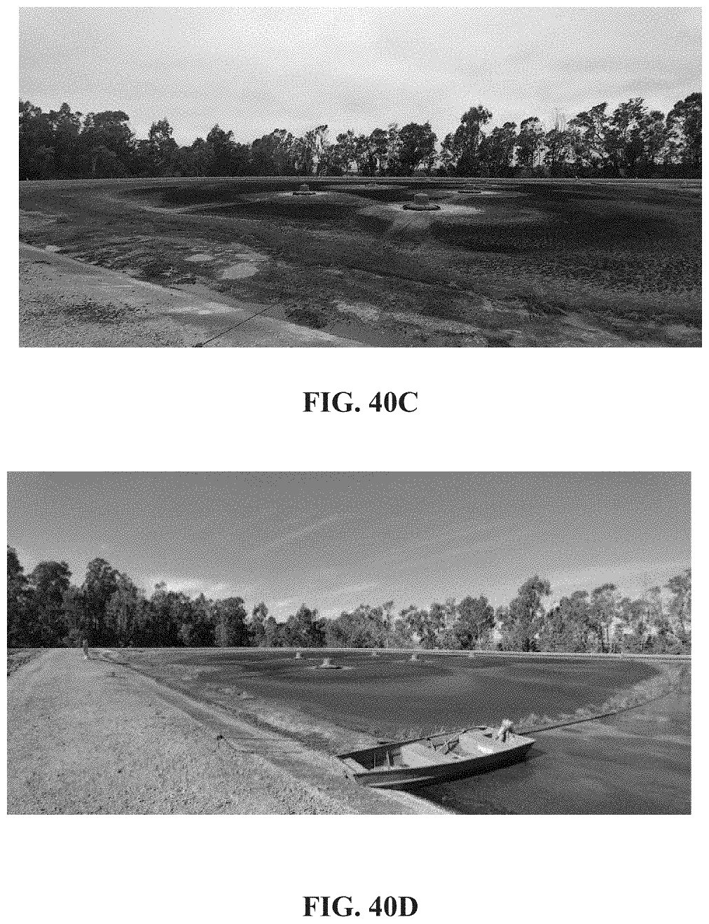

Stage1—FIGS. 38, and 40A, during start-up, the zone of influence (ZOI) continuously expands as granules produce gas in an ever-expanding concentric circle around each circulator. This stage lasts roughly 4 months.

Stage2—FIG. 38 (@8 months), as gas formers reach the berm/bottom interface, there is a sharp, disturbed surface/inert surface, straight-line interface that defines the intersection of the berm with the bottom. Grass begins to appear along the partial depth floating baffle (FIG. 40D). This stage lasts between 4months and one year.

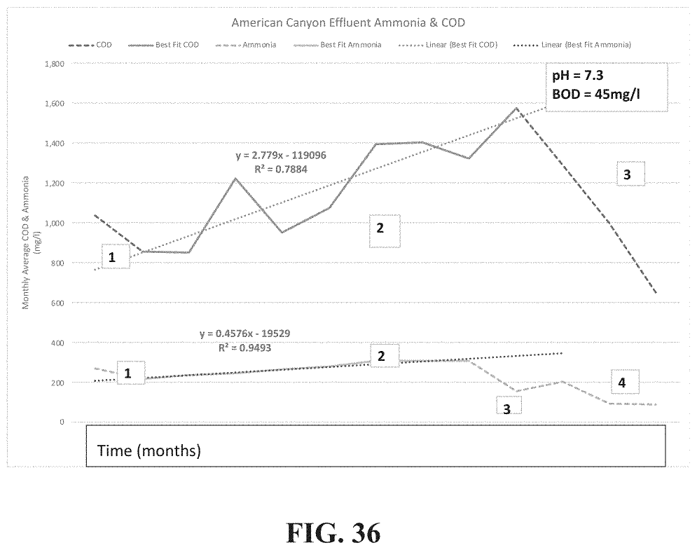

Stage3—FIG. 36, measurement of COD and ammonia concentration in returned supernatant correlates with carbon recycled by bacteria and fungi. Ammonia concentration is directly proportional to the carbon recycled by bacteria. There is N in VS that becomes ammonia. COD concentration (mostly VFA) is directly proportional to the carbon recycled by fungi. VFA is the waste product of oxic/facultative bacteria and is therefore not biodegradable by aerobic bacteria. There is no N in NVS. As seen from FIG. 40C-40D, the berm recedes indicating that berm avalanches have started.

Stage4—all sludge from the berm is gone, and grass sinks from view.

The root cause of increased sludge digestion demonstrated in FIGS. 30 and 31 is physical hydrolysis at the oxic/facultative interface.

Upstream clusters (cluster 5000 of FIG. 29) allow downstream quiescent zones to layer as shown in FIG. 13) into an upper high surface tension zone and a lower low surface tension layer.

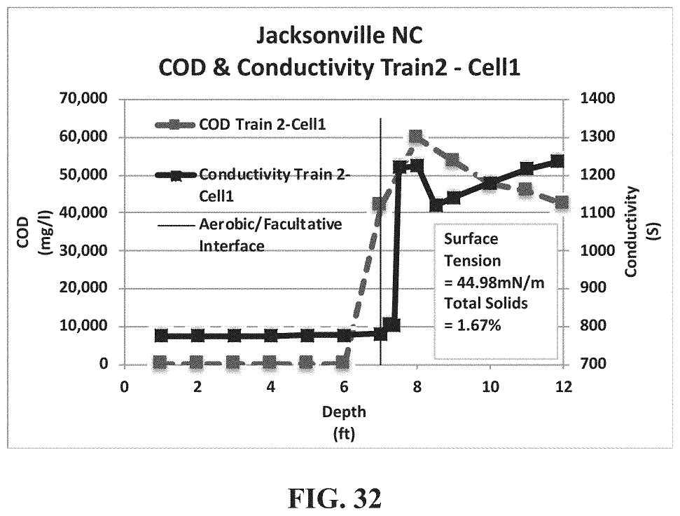

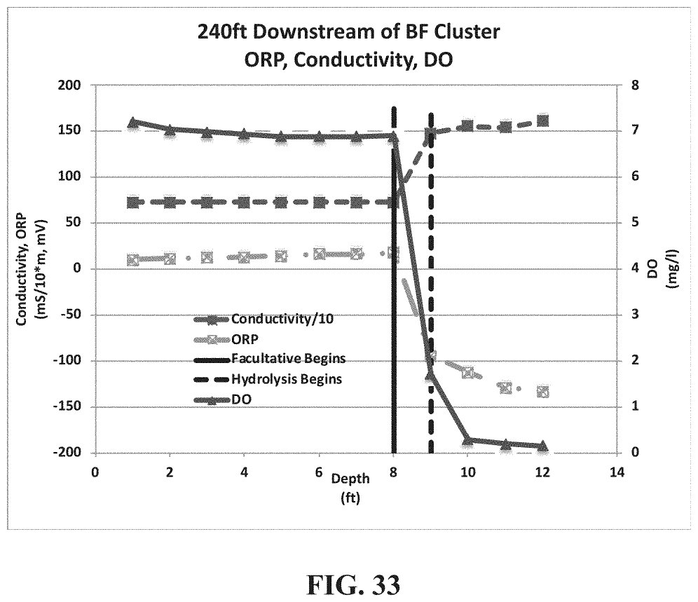

The net effect is to increase gas production. As shown in FIG. 32, chemical oxygen demand (COD) increases from 225 mg/l to 42,000 mg/l across the 3″ interface. There is a further COD increase to 60,000 mg/l below the interface. This continued 240 ft downstream of the cluster, as illustrated in FIG. 33. There is a discontinuity in dissolved oxygen (DO), oxidation reduction potential (ORP) and conductivity during the physical hydrolysis (@8 ft). Then, at 9 ft, biochemical hydrolysis begins with linear changes in DO, ORP and conductivity. There is no measurable sludge downstream of the cluster 5002 of FIG. 29.

It is known that sludge can be characterized as “volatile solids” and “non-volatile solids”. Volatile Solids (VS) are generally considered to be digestible by bacteria, as they are sugars, starch, protein and as disclosed above, volatile fatty acids; non-volatile solids (NVS) are generally considered to be digestible by fungi but recalcitrant to bacteria, as they are cellulose, or lignocellulose based. In lagoon systems, the activity of fungi is so limited that it is ignored; NVS are generally considered as “non-digestible” solids. NVS is calculated as the difference of Total Solids minus Volatile Solids. COD is the sum of VS and NVS, expressed as oxidizable carbon.

It can be expected that a layer of non-digestible solids in the final cell of a lagoon such as a sandbar (3004 of FIG. 14). These results presented in FIGS. 30-33 are totally unexpected.

Further, there is another, never seen before force improving gas formation results in this example, that of activating the indigenous anaerobic fungi in the pond using intentional cavitation and hydraulic walls to encourage growth of anaerobic fungi in the formed granules. Activating fungi is responsible for the sharp drop in the sludge level.

Fungi can be seen by comparing the photograph of a fully mature granule (FIG. 35) with the immature granule of Example 4, shown in FIG. 28. The Example 4 crystal is coated with a black anaerobic bacterial biofilm. The Example 5 granule still has the dark core, but it is now brown, not black. There are also peripheral darker brown (anaerobic fungi) zones and gray (facultative bacteria) zones.

The results illustrated in FIGS. 32 and 33 are when suspended solids are hydrolyzed, one byproduct is fatty acid (“soap”). This lowers surface tension, making large bubbles below the oxic/anoxic interface. Surface tension is a force that creates the smallest possible bubble size.

Clean water is above the interface (high surface tension). As an individual produced-gas bubble passes through the interface (vertical lines of FIGS. 32 and 33) it is small on top, large on the bottom. This inherently unstable geometry flips over. But now the large bottom bubble becomes a small top bubble and vice versa. The net is that the bubbles are continuously flipping back and forth with such violence (“cavitation”) that falling intact bacterial cells are physically torn apart, releasing their internal electrolytes (increases conductivity), internal carbon (higher COD), consuming DO, lowering ORP and releasing digestive enzymes for increased biochemical hydrolysis in water below the oxic/anoxic interface.

Below the interface, COD increases from 42,000 to 60,000 mg/l, a 43% increase. The interface-released digestive enzymes attack cell fragments and any surviving intact cells and increase COD. Thereafter, conductivity increases (from released electrolytes) and COD decreases (from gas formation). The difference is quite dramatic. This change is largely due to reducing the VS in the sludge.

When bacteria convert VS into gas, the concentration of NVS increases. This increases the substrate fungi prefer. Eventually fungi infiltrate the mineral-based, anaerobic granule. Fungi convert cellulose into VFA, just as bacteria convert polysaccharides into the same VFA. Anaerobic methanogens convert both the bacterial-produced VFA and the fungi-produced-VFA into methane and CO₂. Gas production increases. Increased gas helps granules migrate by lifting immature granules and letting them “fly” upstream and downstream across the entire flat bottom of the pond.

The process flows are as follows: Volatile Solids: SBOD+O₂→TSS (via aerobes)→VFA (via facultative bacteria)→Gas [via Anaerobic Bacteria]; and Non-volatile Solids: Lignocellulose→VFA (via anaerobic fungi)→Gas [via Anaerobic bacteria]

Eventually the entire downstream flat portion of the pond has no measurable sludge. This anaerobic fungi activity has never before been reduced to practice.

The fungi effect is further discussed below:

Wasted sludge consists of water, nutrients, volatile and non-volatile solids, Volatile Solids (VS) are generally considered to be digestible by bacteria. Non-volatile solids (NVS) are not digestible by bacteria. VS primarily contain sugars, starch, protein, fat and similar compounds. NVS primarily contains crystalline cellulose, amorphous hemicellulose, lignin (a ring-based compound with short aliphatic branches) and mineralized grit.

Nature provides different pathways for decomposing VS and NVS:
1. Bacterial conversion:
   a. VS→Volatile Fatty Acids (VFA) Gas
2. Fungal conversion:
   a. Cellulose+hemicellulose→VFA (via fungi)→Gas (via anaerobic bacteria)
3. Chemical oxidation of lignin to biodegradable compounds
4. Mineralized grit→topsoil.

Modern waste treatment systems bypass the fungal step and the lignin oxidation step. Treatment processes use various bacteria to remove VS then land apply NVS.

The circulators of the present disclosure can mimic the gentle mixing of the grass-grazing animal rumen at the base of the lagoon water column.

Typically, ruminants eat rapidly to minimize predator attack. They find a safe place to rest and “chew their cud”. Soluble sugars in the grass support rapid fungal growth as aerobic ingested material transfers to anaerobic downstream stomachs. in the downstream stomachs, fungi convert cellulose, hemicellulose, ammonium and minor nutrients into fungal mass, protein, simple sugars and VFA. Anaerobic bacteria convert VFA into gas. The stomach gently moves during digestion, mixing fungi, bacteria, nutrients and substrate together.

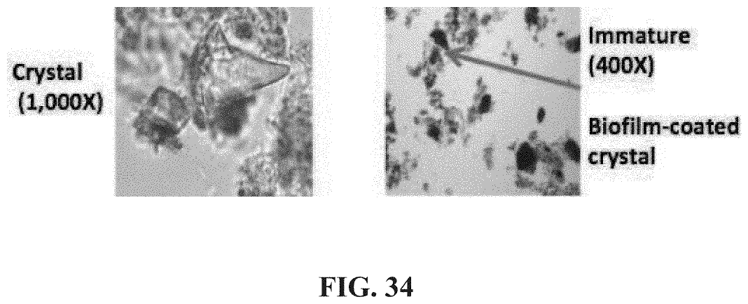

The disclosed circulator mimics this gentle movement in the stomach of ruminants to encourage fungi growth by forming crystals by intentional cavitation, which allows for a gas-forming biofilm to adhere to the crystal surface, as shown in FIG. 34.

Facultative bacteria adhere to the biofilm, seen as a light tan color in FIG. 35. Together, a heavy granule is formed that converts VS to gas at the base of the water column, as shown in FIG. 35.

After heavy granule formation, eventually, granules pile on top of each other until heavy enough to break through the biosolid sludge blanket surface. Gas is then formed under the blanket, destabilizing it. As gases are produced and rise, the heavy granules mix, which substantially mimics a ruminant stomach.

VS conversion to gas increases the nutrient density, creates a 6.2-7.5 pH zone and, by difference, increases the NVS concentration in the mixing zone, which makes conditions favorable for fungal growth. Inherent fungal spores (darker brown background color in FIG. 35) infiltrate the granule. The fungi establish rhizoidal roots around NVS and begin the cellulose and hemicellulose conversion to VFA. Existing anaerobic biofilm around the crystal converts fungal VFA and facultative bacterial VFA into gas. Gas production “doubles”; mixing increases; sludge mass is reduced rapidly.

Then, fungi mature and produce spores, growing exponentially up to the food available, consuming legacy sludge. COD (mostly lignin) increases until legacy sludge is gone, then stabilizes, due to fungal activity on NVS. Along with sludge consumption, ammonia increases due to bacterial activity on VS and the rate of COD increase (shown in FIG. 36) to the rate of ammonia increase is 6:1.

The ratio of N:C is fixed in bacterial cells (@˜5%). If all the sludge decrease were bacterial, the slope of the COD and ammonia increase would be similar, however as can be seen in FIG. 36, the slopes are very different, indicating an alternate mechanism of action. Lagoon COD and ammonia stabilize after the legacy sludge is gone as the only food is incoming WAS.

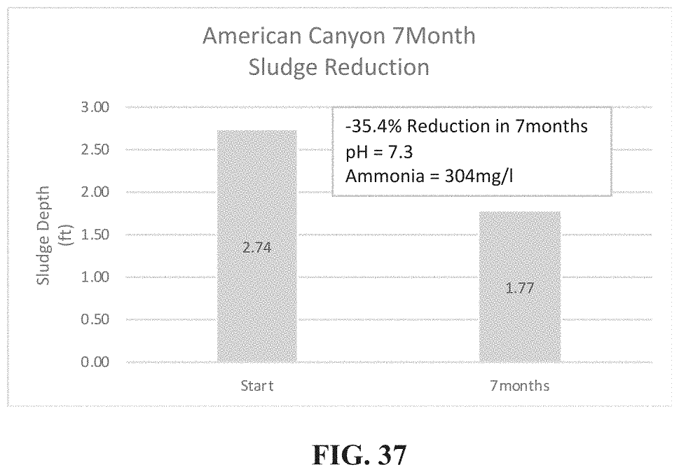

FIG. 36 and FIG. 37 support this, showing a reduction in sludge of 35.4% over 7 months.

In FIGS. 36 and 37, are of a sludge holding pond of 1.4 MGD Membrane Bio Reactor (MBR) influent was 0.026 MGD of WAS TSS is 6,654 mg/l; effluent TSS is 220 mg/l. Effluent COD was 1,576 mg/L; effluent BOD was only 45 mg/L. The difference is likely lignin. Importantly, TS was reduced, but the VS/TS ratio did not vary significantly. This indicates that both VS and NVS were attacked.

The best fit line for Stage 2 is shown as a dotted line for both ammonia and COD. The sludge stages are numbered in FIG. 36.

The slope of the Stage 2 COD line is 6× the slope of the Stage 2 ammonia line.

The change from Stage 1 to Stage 2 for COD and ammonia began the same month.

The change from Stage 2 to Stage 3 for ammonia occurred in at a period in time; for COD it occurred one month later.

COD concentration peaked at 1,576 mg/L; that same month the BOD was only 45 mg/l, a 35:1 ratio. Typical municipal COD:BOD ratios are 2:1, suggesting that the released COD was not biodegradable.

Facultative bacteria convert VS into VFA and ammonia; fungi convert NVS into WFA. These are two very different reactions and it is expected that the response curves are different.

If bacteria were responsible for the COD response, then the Stage 2 best fit lines of ammonia and COD would have similar slopes; they do not. The transitions from 2 to 3 and 3 to 4 are dissimilar, also suggesting differing mechanisms of action.

Since the 12 month sludge measurement showed little residual sludge and the berm sludge is gone, both VS and NVS had to go somewhere to keep mass in balance. Both VS and NVS were turned into gas.

Facultative bacteria turn dead bacterial cells (VS) into VFA, releasing ammonia. Anaerobic fungi turn cellulose and hemicellulose (NVS) into VFA. Anaerobic methanogens indiscriminately turn VFA from both bacterial and fungal sources into CH₄ and CO₂. Grit accumulates.

The sludge reduction illustrated in FIG. 37 is based on a reduction of the following sludge components:
1. Volatile Solids
   a. Primarily dead bacterial cells with about 5 wt % N
      i. Facultative Bacteria+VS→VFA+NH₃→Gas (via anaerobic bacteria)+NH₃
2. Non-Volatile solids
   a. Primarily N-free cellulose, hemi-cellulose & lignin
      i. Anaerobic fungi+NVS→VFA→Gas (via anaerobic bacteria)
         1. Lignin is not digested and leaves as effluent COD
         2. There is no N in Non-Volatile Solids
3. Grit
   a. Primarily insoluble mineral salts and miscellaneous “bits”
      i. Grit is not digested and accumulates
      ii. Small mineral salts are commingled by aerobic worms into castings.
      iii. Ejected castings can escape in effluent as slightly elevated TSS
      iv. “Bits” accumulate and are eventually dredged

Sludge removal goes through 4 distinct stages: the first stage is “start-up” where granules are selected and then migrate across the entire bottom; the second stage is “bottom cleaning” where granules turn bottom solids into gas and/or grit; the third stage is “berm cleaning” where undermined berm sludge avalanches onto the bottom for conversion to gas and/or grit; and the fourth stage “steady-state” where granules are perpetually semi-starved once legacy sludge is gone and the only substrate is incoming solids.

The four sludge removal stages can be delineated by: (1) Direct measurement of sludge volume, which has the real benefit of quantifying the volume (or mass) of sludge removed from the pond and is useful when confirming warranty compliance, but is onerous; (2) Monthly photographic records, which have the real benefit of visualizing the very complex biochemistry occurring below the water surface for Operators and Managers, but pictures are an inexact science; (3) Effluent water chemistry, which measures effluent COD, which correlates to anaerobic fungal hydrolysis of NVS, measures effluent ammonia, which correlates to bacterial hydrolysis of VS, measures effluent pH to confirm that acid producers and acid consumers are sufficiently matched so that produced alkalinity can buffer to near neutral pH. When Stage 4 low concentrations of COD and Ammonia are achieved, it can be determined that the pond has reached steady state.

Steady State does not mean the pond is clean. When the COD line of FIG. 36 is increasing linearly, this means that the fungal conversion of NVS to VFA exceeds the anaerobic bacteria conversion of VFA to gas by a fixed amount (i.e. the slope of the curve).

As the rate of COD drops, this means that the NVS “load” is dropping and anaerobic conversion to gas is “constant”, but the mismatch is dropping because the “inventory” of NVS is dropping. Not yet shown on the chart, the COD will eventually level out meaning that fungal VFA formation is matched by anaerobic bacterial conversion of VFA to gas.

This has never been reduced to practice in wastewater lagoons.

The direct measurement of sludge volume during each of the sludge removal stages discussed above are now discussed. In Stage 1, there is no change in sludge volume as activity is limited by the extent of granule propagation. In Stage 2, sludge volume increases as produced gas occludes to TSS and “leavens” the sludge blanket. In Stage3, once total bottom solids (TS)<2.5%, gas escapes and blanket volume declines. In this Stage 3, as bottom solids become gas, berm solids are undermined and become unstable, and then “avalanche” onto the bottom where they become gas. In Stage 4, the bottom and berm are clear, and granules are perennially starved. These granules continue to grow up to the sum of incoming solids and legacy solids and when legacy solids are gone, the only food is incoming WAS keeping the remaining granules semi-starved.

### EXAMPLE 6

Example 6 is a worst-case scenario in that WAS (waste activated sludge) from a modern treatment plant is discharged into a sludge holding lagoon. The incoming WAS is TSS=6,654 mg/L from an MBR (Membrane BioReactor, a particular kind of aeration system). Solids are wasted into a holding lagoon for stabilization and eventual dredging of high solids waste to a landfill. Effluent TSS=220 mg/l.

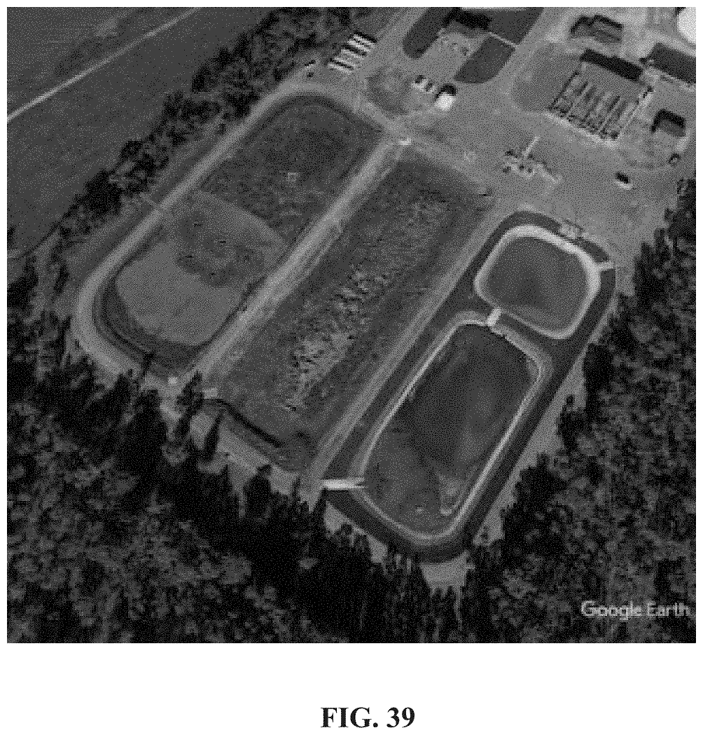

A cluster of circulators in the orientation shown in FIG. 10a was installed. FIG. 38 includes Photographs show the pond starting up, and over time. The photo in FIG. 39 is an overhead photo of the sludge lagoon to the west showing the cluster of circulators.

Sludge depth was measured before the start-up and after 7 months. Sludge was reduced by −35.4%. Returned supernatant had a TSS=220 mg/L, about the concentration of incoming untreated water. COD varied from 835 mg/L to 1,576 mg/L, typical of supernatant returning to the headworks of the plant. The BOD is low, 45 mg/L. Results are shown as part of the fungal discussion above, in FIGS. 36 and 37.

Sludge holding ponds are designed to allow natural conversion of some carbon into gas and produce stabilized solids. Stabilized solids accumulate for years until dredged.

In this pond of FIG. 39, with 5 circulators in a 3:2 cluster (in the orientation of circulators in FIG. 10a less 4 circulators) plus an optional cross pond baffle (of circulators in the orientation of circulators shown in FIG. 10a) the pond is designed to create selected granules and then have them migrate across the entire pond.

The pictures demonstrate that this task was completed after 8months in this pond. The key visual is that there is a straight line between the produced-gas-bubble-disturbed surface over the flat and the angled berm in the 8 month picture. This occurs because granules have migrated to the berm/flat interface. Then at 10 months (as shown in the photograph of FIG. 40B), the sludge on the angled berm started to “avalanche” onto the flat. This is observed by comparing the 8 month photo (FIG. 38) with the 10 month photo (FIG. 40B). In the 10 month photo, the gas-disturbed area has encroached on the berm. The avalanches are caused by selected bacteria and fungi undermining the sludge sitting on the angled berm. When the sludge overhang is large enough, it breaks off (“calves”) and flows onto the flat where it is turned into gas.

Sludge holding ponds are particularly foul. Removing sludge from them is unexpected. COD is an excellent metric for defining the various steps that sludge ponds progress through as they transition from foul to “clean” as shown in FIG. 36.

The process in the sludge holding ponds over time is discussed below:

In the first step, initiation, granules are forming, maturing and migrating across the entire flat of the pond, while effluent COD is constant. In the second step, migration, after completing migration across the flat, granules attack substrate, producing gas, CO₂ and converting solids into SBOD, which is a volatile solid.

In the third step, carbon removal, the macro capacity of granules to convert solids to gas is finite, particularly after easy-to-digest solids are consumed, leaving gel behind, heavy gel has a generally flat surface; granules are generally spherical. The touch-point area between a sphere and a flat is small, restricting the activity such that all SBOD (˜volatile solids) is converted into gas without excess SBOD. [Excess SBOD would measure as BOD; in this case, the BOD/COD is ˜25:1 (220/45)]. Typical waste treatment plants have COD-to-BOD ratios of about 2:1.

In the fourth step, which continues after the third, eventually the solids gel is destabilized, granules fall through the gel, produced gas rises and further destabilizes the gel, mixing granules with gel fragments, COD declines because the pond COD is reduced. Eventually the COD line will flatten as the pond becomes clean, as fragmented gel is turned into SBOD and then into gas. There is a linear reduction in COD as residual carbon declines. Sludge disappears as gas; effluent COD declines. VS is reduced by bacteria; NVS is reduced by fungi.

### EXAMPLE 7

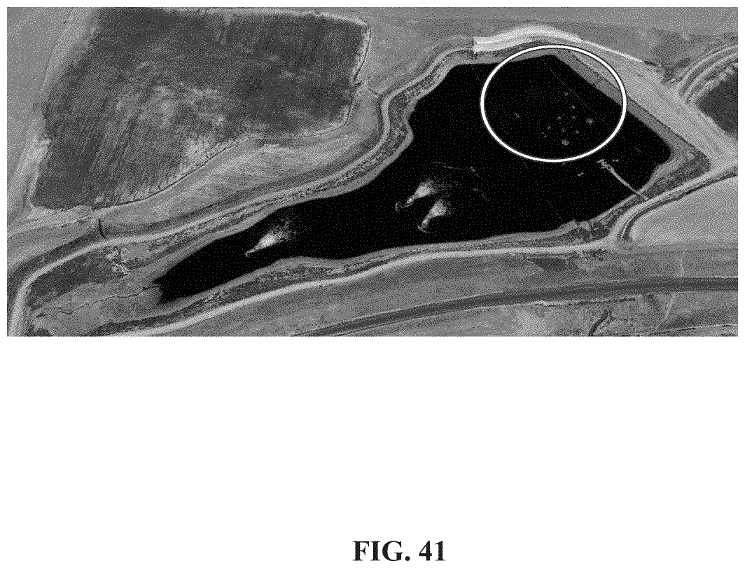

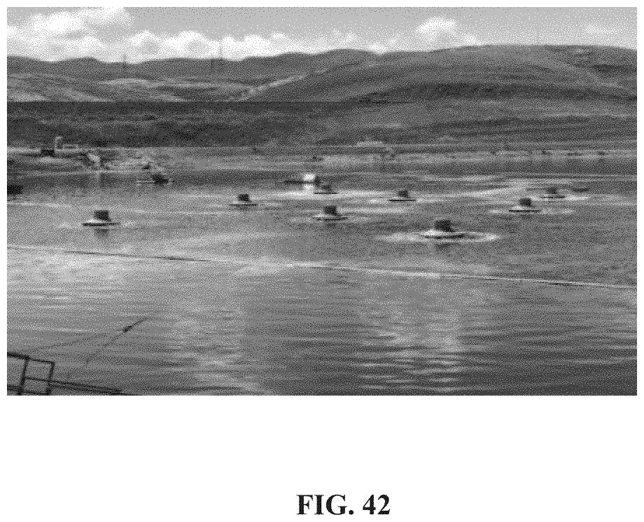

FIG. 41 is a top view of a pond (with FIG. 42 being a side view of the same pond) with a number of circulators in the same configuration as that show in FIG. 11D in the white ring of FIG. 41.

The results of using the circulators in FIG. 41 are shown in FIG. 15, and FIG. 16.

This is an 8 pack cluster of circulators in FIG. 41 are in a 40 ft deep reservoir with a porous bottom. The reservoir was formed by damning a stream and then seasonally filling the reservoir with rainwater and briny, plant waste water. Water is sprayed on fields during dry weather.

In FIG. 15, the chloride content of the surface water was analyzed. Chloride increases after the rainy season as water evaporates. Shortly after the 8 pack cluster of circulators was started up, a surprising reduction of chloride (in the dry season) occurred. In FIG. 16, the corresponding surface DO varied around a mean close to 1.25 mg/L. After start-up, DO dropped to 1.1 mg/L and then increased to 1.35 mg/L. The peak chloride occurs before the DO dip. Chloride concentration and surface DO both stabilize. The permit requires ≥1 mg/l DO at the surface.

In the pond of FIG. 41, an unexpected spike in Chlorides was followed by a sharp drop. Simultaneously, the surface DO drop and then recovery at a higher level is unexpected.

Bacterial growth consumed oxygen, but because the produced floc was heavy from the embedded crystal, bacteria sank. The bacteria consume salt as part of its internal need for electrolytes. The heavy floc sinks, transferring internal dissolved salt from the surface, where formed, to the pond bottom. Granules then digest the heavy floc at the bottom. Carbon is turned into gas; released electrolytes percolate through the porous bottom into the groundwater. DO drops before chlorides drop because bacterial growth precedes bacterial sinking. Once the surface water is “clean”, there is reduced bacterial activity and DO rises as continuous wave activity increases macro surface area surface DO.

### EXAMPLE 8

FIG. 18 is an 8 pack cluster template of circulators in a paper mill lagoon. The blue circles are circulators; the white lines are the hydraulic wall shown in FIG. 17, except FIG. 18 is an 8 pack cluster (also shown schematically in FIG. 11D). Waste in paper mill lagoons is different than municipal wastewater lagoons in that the sludge is largely non-volatile lignocellulosic material and little ammonia.

FIG. 13 is a typical cross section of a lagoon downstream of any of the cluster configurations shown. FIG. 14 shows the lignocellulose build-up downstream of the 35 MGD influent point. Water finds the path of least resistance (3002 white curvilinear arrow) and drops out silt (3004). Wastewater 3022 is aerated in aeration basin 3022. The objective of aeration basin 3022 is to chemically convert the lignocellulose into a partially oxidized substrate that is biodegradable with bacteria. Most of the solids are removed in clarifier 3023.

Water and remaining hard-to-settle solids transfer into lagoon 3000. Solids create a “sandbar” 3004 of lignocellulose that forces water 3002 to follow a tortuous path into downstream zone 3000. The 8 pack cluster of circulators, as shown in FIG. 18, is installed (shown as expanded 3040 and 3042 in the downstream cell) but in actual as-installed scaled size is 3044, 3046 and 3048 (n=3×8 pack clusters; individual circulators are not shown for scaling clarity).

The area away from the cluster stratifies as per FIG. 13. The top of the water column is clear, allowing some light to penetrate. At the bottom, complex anaerobic granules form, lowering surface tension. At the oxic/anoxic interface, bacterial cells are physically lysed. In the lower produced-gas mixing zone 2305, biochemical hydrolysis occurs. Sludge is reduced slowly to avoid upsetting downstream receiving streams.

Skilled artisans know that legacy paper, sludge holding ponds eventually fill up with lignocellulose solids. The objective is to chemically convert lignocellulosic materials into partially-oxidized biochemical compounds that bacteria can turn into gas and to activate fungi.

The FIG. 18 plurality of 8 pack clusters of circulators does not fully treat 35 MGD, instead, the 8 pack cluster of circulators “inoculates” the pond with mineral-based granules that can migrate and proliferate across the entire pond flat. An important aspect is to build an anaerobic methanogen biofilm on the outside of the mineral salt crystal. Then build a scaffold of facultative bacteria attached to the methanogen biofilm. This combination performs these steps: 1. Bacterial Solids→SBOD; 2. SBOD→VFA; and VFA→Gas.

This will continue for about one year. As the BOD declines and the lignocellulose is untouched, the relative concentration of lignocellulose increases. Eventually, anaerobic fungi are attracted to the increasing food source and infiltrate the bacteria/crystal granule and target the lignocellulose. Infiltrated granules will then perform these additional steps: 1. Cellulosic solids→VFA; and 2. VFA→Gas.

The VFA from both routes, bacterial VFA and fungi VFA are chemically same compounds (C1, C2, . . . C6 fatty acids). The existing anaerobic, methanogen biofilm converts bacteria-sourced VFA and fungi-sourced VFA into gas indiscriminately. There is a significant time lag between removal of bacterial solids and removal of lignocellulose solids. Once this incubation is complete, the now-propagated and migrated granules consume both volatile solids and non-volatile solids. Produced gas increases, mixing the facultative layer 2305 of FIG. 13.

### EXAMPLE 9

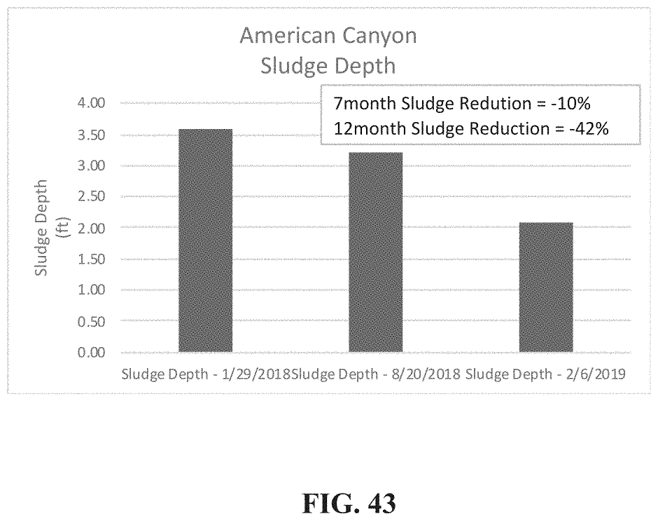

In this example a sludge holding pond for a 1.4 MGD (million gallon per day) wastewater treatment plant was equipped with five circulators were placed in the configuration of FIG. 10A (with the five circulators being in the locations of 1111A, 1111B, 1111G, 1111F, and 1111E). These circulators were placed about 44 feet apart and were operated in reverse (aeration mode) for 12 months. FIG. 43 illustrates the depth of the sludge before, after 7 months and after 12 months. There was a significant difference.

Generally, sludge holding ponds are slightly active, but need to be dredged every 3-5 years. What is unexpected is the digestion of both volatile (dead bacteria) and non-volatile (cellulose and hemicellulose) solids. This means that volatile solids were digested using well known anaerobic and facultative bacteria, but to a greater extent than ever before. But totally unexpected, was the use and ability of anaerobic fungi (likely from ruminant animals like deer, horses, cows, sheep) to remove non-volatile solids.

This discussion has not yet addressed the removal of grit. Grit is defined as coarse solids (e.g. fragmented plastic tampon inserters) and fine grit (e.g. calcium salts of various types). The BF circulator running in mix mode (7 MGD) at the terminal end of the pond and placed 75-125 ft from the effluent creates perimeter flow. Perimeter flow brings 1 mg/l DO-water across the surface, down the berm and swirls back into the perimeter flow BF suction. The net effect is to bring low levels of DO to the sludge/water interface sufficient to let worms thrive. Worms receive oxygen by transfer through the linear wiggling torso. They feed indiscriminately head down, tails up. Fine grit and digestible matter are commingled and excreted as tiny spherical castings. Perimeter flow receives vertically-discharged castings and eventually they leave as slightly elevated TSS.

This process does not happen until the pond reaches Stage 4 because sludge in the earlier stages consumes any DO at the sludge/water interface. Only when the pond is biologically clean, can worms survive. Then they clean fine grit and dead algae.

Systems described herein above can be mathematically modelled using a power algorithm.

For example, the number of circulators is related to the flow rate by a power curve wherein the flow rate (MGD) is raised to the −0.44 power. The correlation R\hat{ }2 is >0.95.

As used herein, the terms “BOD” refers to biochemical oxygen demand.

The term “MGD” means Million gallons per day

The term “ORP” refers to Oxidation Reduction Potential, a measure of how anaerobic a system is

“VFA: stands for volatile fatty acid.

The term “TSS” refers to total Suspended Solids.

The term “COD” refers to Chemical Oxygen Demand.

The term “DO” refers to dissolved oxygen.

Te term “rpm” refers to revolutions per minute,

The described embodiments of the present invention are intended to be illustrative rather than restrictive, and are not intended to represent every embodiment of the present invention. Various modifications and variations can be made without departing from the spirit or scope of the invention as set forth in the following claims both literally and in equivalents recognized in law.

What is claimed is:

1. A treatment system in a lagoon containing water that promotes the formation of biologically active granules that digest sludge in the lagoon, the lagoon comprising a bottom thereof, the water of the lagoon having a surface layer, the system comprising:
(i) X number of water circulators in a cluster having an impeller disposed in the lagoon, wherein X is greater than or equal to three, at least one of said X number of water circulators being configured to: move water horizontally and radially from the centerline of each circulator independent of the direction of rotation of the circulator impeller.
(ii) hydraulic walls formed from at least some of the water expelled from each of any given pair of adjacent water circulators, wherein each of the hydraulic walls intersects in a substantially straight line at the midpoint of any two adjacent circulators, said hydraulic wall redirecting the expelled water downward towards the bottom of the lagoon, wherein the hydraulic walls at least partially separate occluded gas from the redirected water.

2. The system of claim 1, wherein independent, substantially straight hydraulic walls completely surround at least one circulator.

3. The system of claim 1, wherein the hydraulic walls completely surround at least two circulators.

4. The system of claim 1, wherein X is 5.

5. The system of claim 1, wherein X is 8.

6. The system of claim 1, wherein X is 11.

7. The system of claim 1, wherein the lagoon receives an inflow of at least 10 million gallons per day (MGD), at least 15 MGD, at least 20 MGD, at least 25 MGD, at least 30 MGD, at least 35 MGD or at least 40 MGD.

8. The system of claim 1, wherein a dimensionless ratio of a flow rate of the reciprocating water circulator per influent gallons per day ranges from about 0.5 to about 15, about 1 to about 5, about 1.2 to about 3, about 1 to about 2 or about 1.4.

9. The system of claim 1, wherein the lagoon is a paper mill lagoon.

10. The system of claim 1, wherein the water in the lagoon was previously treated to aeration prior to entering the lagoon.

11. The system of claim 1, wherein the fluid in the lagoon was passed through a clarifier prior to entering the lagoon with a solids-lean fraction discharged to an external receiving means and a solids-rich fraction discharged to the lagoon.

12. A treatment system for a lagoon containing water that promotes the formation of biologically active granules that digest sludge in the lagoon, the lagoon comprising a bottom thereof, the water of the lagoon having a surface layer, the system comprising: Y number of clusters of water circulators disposed in the lagoon, wherein Y is 2, 3, 4, 5, 6, 7, 8, 9, 10, 11, 12, 13, 14, 15, 16, 17, 18, 19, or 20; each of the Y number of clusters of water circulators comprising the system of claim 1.

13. The system of claim 1, wherein the pH of the lagoon effluent is ≥7.5.

14. The system of claim 1, wherein in a downstream portion of a circulated volume of water, a column of water in the pond stratifies into an upper oxic zone and a lower anoxic zone.

15. The system of claim 1, wherein the cavitation of at least one of the circulators forms a mineral crystal in the water.

16. The system of claim 15, wherein an anaerobic bacterial film forms on the crystal.

17. The system of claim 16, wherein an anaerobic fungal film forms outboard of the anaerobic bacterial film on the mineral crystal.

18. The system of claim 16, wherein the fungal film is capable of digesting non-volatile solids in the water.

19. The system of claim 16, wherein the fungal film converts a cellulose and a hemicelluloses in the water to volatile fatty acids (VFA).

20. The system of claim 19, wherein the bacterial film converts the VFA to a gas.

21. The system of claim 1 in which volatile solids are reduced.

22. The system of claim1 in which non-volatile solids are reduced.

23. Granules produced by the process of claim 1.

24. The system of clam 1, further comprising a terminal horizontal, radial outflowing circulator positioned 50 to 150 ft from an outlet of the lagoon such that a dissolved oxygen at a sludge water interface is greater than 0.5 mg/l, wherein non-digestible solids are commingled with digestible solids such that grit is removable from the lagoon.

25. The system of claim 1, wherein the system comprises a linear cluster of horizontal radial outflow aerating circulators, each circulator comprising a radially attached growth surface such that hydraulic walls are formed at the midpoint between adjacent clusters, wherein the system reduces Total Nitrogen by more than 85%.

26. The system of claim 1, wherein a mixed liquor fluid is added to the lagoon, wherein the mixed liquor fluid is a fluid with greater than 1,000 mg/l suspended solids that was not passed through a clarifier prior to addition to the lagoon.
